(19) United States
(12) Patent Application Publication
(10) Pub. No.: US 2014/0375650 A1
(43) Pub. Date: Dec. 25, 2014

(54) SYSTEMS AND METHODS FOR DATA VISUALIZATION

(71) Applicants: Thomas Grundstrom, Cary, NC (US); Mark Gorton, Wake Forest, NC (US); Jill W. Collins, East Greenwich, RI (US); Amy Kissam, Alpharetta, GA (US)

(72) Inventors: Thomas Grundstrom, Cary, NC (US); Mark Gorton, Wake Forest, NC (US); Jill W. Collins, East Greenwich, RI (US); Amy Kissam, Alpharetta, GA (US)

(73) Assignee: Quintiles Transnational Corporation, Durham, NC (US)

(21) Appl. No.: 13/925,232

(22) Filed: Jun. 24, 2013

(51) Int. Cl. G06T 11/20

(52) U.S. Cl. CPC G06T 11/206
USPC 345/440

(57) ABSTRACT

Systems and methods for data visualization are disclosed. For example, one disclosed method, includes receiving data from a clinical trial, retrieving data relevant to a study indicator (SI) from a plurality of data entities, and calculating a plurality of SI values, each calculated SI value based on the data from one of the plurality of data entities. The method further includes generating a graphical visualization that includes a graphical region indicating one or more ranges of values, a plurality of graphical indicators, each of the plurality of graphical indicators corresponding to one of the of plurality of SI values, wherein each of the plurality of graphical indicators is positioned within the graphical region based on the respective corresponding SI value and the one or more ranges of values, and displaying the graphical visualization.

### CROSS-REFERENCE TO RELATED APPLICATIONS

This application claims priority to U.S. Provisional Application No. 61/663,216, filed Jun. 22, 2012, entitled “Systems and Methods for Data Visualization,” the entirety of which is hereby incorporated by reference.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### FIELD

The present disclosure relates generally to data visualization and more specifically relates to data visualization for clinical trials.

### BACKGROUND

In a clinical trial, it is common for a clinical research organization (“CRO”) to receive large quantities of clinical trial data from a multitude of different sources at a large number of different clinical trial sites. Each of the different clinical trial sites may collect and submit a variety of information, including lab results, patient enrollment information, adverse events, etc. This data may be used to determine the efficacy of a new drug or treatment being tested, common side effects, and potential risks. However, a properly-executed clinical trial must be performed according to certain procedures defined for the clinical trial. Failure to adhere to the procedures can result in poor quality or unusable clinical trial data and, consequently, can cause inaccurate and misleading results.

### SUMMARY

Embodiments according to the present disclosure provide systems and methods for data visualization. For example, in one embodiment of a method disclosed herein, the method comprises receiving data from a clinical trial; retrieving data relevant to a study indicator (SI) from a plurality of data entities; calculating a plurality of SI values, each calculated SI value based on the data from one of the plurality of data entities; generating a graphical visualization comprising: a graphical region indicating one or more ranges of values, a plurality of graphical indicators, each of the plurality graphical indicators corresponding to one of the of plurality of SI values, wherein each of the plurality of graphical indicators are positioned within the graphical region based on the respective corresponding SI value, and the one or more ranges of values; and displaying the graphical visualization. In another embodiment, a computer-readable medium comprises program code for causing one or more processors to execute such a method.

These illustrative embodiments are mentioned not to limit or define the invention, but rather to provide examples to aid understanding thereof. Illustrative embodiments are discussed in the Detailed Description, which provides further description of the invention. Advantages offered by various embodiments of this invention may be further understood by examining this specification.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIG. 1A shows a screenshot from a system for data visualization according to one embodiment;

FIG. 1B shows information about a study indicator according to one embodiment;

FIGS. 2-3 show systems for data visualization according to embodiments;

FIG. 4 shows a method for data visualization according to one embodiment; and

FIGS. 5-22 show visualizations of study indicators according to embodiments.

### DETAILED DESCRIPTION

Example embodiments are described herein in the context of systems and methods for data visualization. Those of ordinary skill in the art will realize that the following description is illustrative only and is not intended to be in any way limiting. Other embodiments will readily suggest themselves to such skilled persons having the benefit of this disclosure. Reference will now be made in detail to implementations of example embodiments as illustrated in the accompanying drawings. The same reference indicators will be used throughout the drawings and the following description to refer to the same or like items.

### Illustrative System for Data Visualization

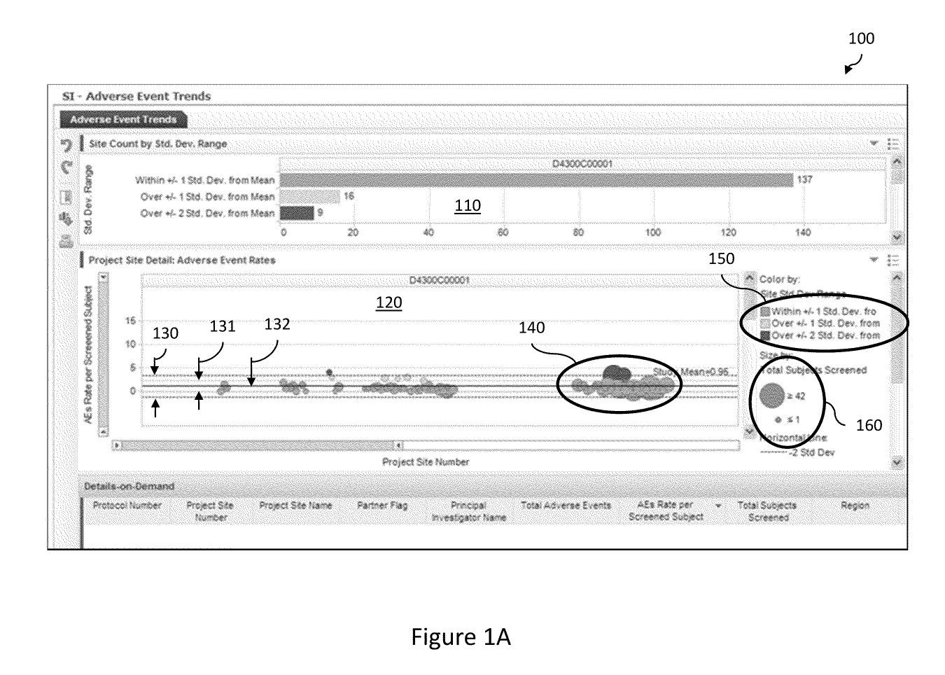

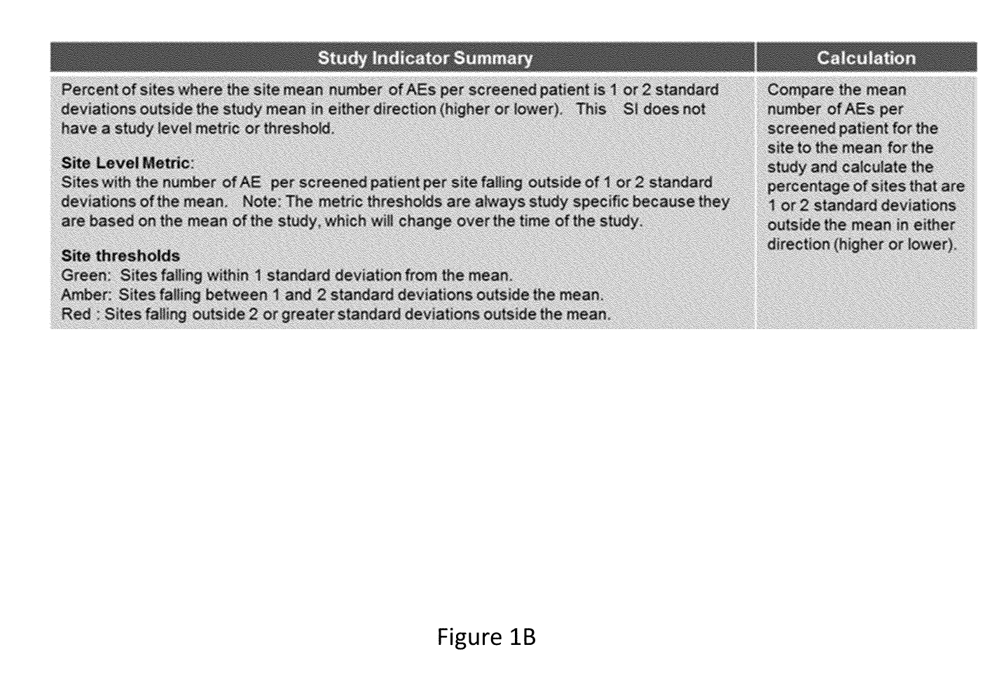

FIG. 1A shows a screenshot 100 from a system 200 for data visualization according to one embodiment. In the embodiment shown in FIG. 1, the system 200 provides a user with a graphical user interface for visualizing data from an on-going clinical trial. In this embodiment, the user is viewing data associated with a study indicator (SI) that has been developed as a metric for identifying potential issues within a clinical trial. In this illustrative embodiment, the system 200 displays values for a SI related to Adverse Events (AE) at a number of different sites included within a clinical trial. Data is received from each of the clinical trial sites on a real-time or near-real-time basis (e.g. daily) and may be integrated within a common data store for the clinical trial. Once data has been received from one or more of the various clinical trial sites, a user may employ this illustrative embodiment to obtain a visualization of various characteristics of the clinical trial.

Referring to FIG. 1B, the chart provides a description of the SI associated with AEs that are then represented within the visualization shown in FIG. 1A. In this case a SI has been defined to analyze adverse events at study sites. As sites report data, that data may include indicators of adverse events. Adverse event data for each site is gathered and the rate of AEs is then compared against a mean value calculated based on the number of AEs occurring in the trial. Thresholds were predefined to indicate when a rate of AEs becomes too high and further attention may be warranted. For this SI, thresholds have been established that are based on a number of standard deviations from the mean rate of AEs for the study. Thus, the visualization shown in FIG. 1A is based upon the definition for this SI.

As may be seen in FIG. 1A, a user is presented with a graphical user interface (GUI) with one or more graphical renderings of one or more SIs based on data received from the various sites. In the embodiment shown, the visualization provides a user with a visualization showing the rate of AEs at each site and whether the AE rate is within an acceptable range, as well as the number of subjects screened at each site. As may be seen, two charts 110, 120 are displayed to a user in this embodiment. The first chart 110 shows a bar graph showing the number of sites having an AE rate within one standard deviation of the mean, the number of sites having an AE rate between one and two standard deviations from the mean, and the number of sites having an AE rate of greater than two standard deviations from the mean. Thus, this chart provides a user with an indication of whether a significant number of AEs are occurring or not.

The second chart 120 shows rates of AEs at each of the sites involved in the clinical trial as well as an indication of the number of subjects screened at each site. As is shown, each site is represented by an indicator, a circle in this embodiment, where the radius of each circle is based on the number of subjects screened at the site corresponding to the circle. Study sites are each assigned a site number, which is provides the basis for the “x” axis. Because of how sites were numbered in this example, circles have been spaced irregularly and are somewhat clumped, such as in region 140. The GUI also provides a reference 160 indicating the minimum and maximum size of circles within this embodiment. In addition, each indicator is placed on the graph according to a SI value. In this embodiment, each circle corresponds to a value indicating the rate of AEs as a number of standard deviations from the mean. As can be seen in the chart 120, reference lines 130-132 are also provided to aid a user viewing the chart 120. Lastly, in addition to its placement on the graph, each indicator is colored based on its value, as is shown in the color key 150: sites having an AE rate within one standard deviation of the mean are colored green; sites having an AE rate between one and two standard deviations from the mean are colored yellow; and sites having an AE rate of greater than two standard deviations from the mean are colored red.

While not shown in this embodiment, it is contemplated that one or more thresholds may be displayed in the first chart 110 as well, such as based on study-level thresholds. For example, a threshold may be displayed to indicate when more than a certain percentage of trial sites are experiencing an elevated number of AEs.

Thus, a user viewing this visualization may be able to review the data presented in the two charts 110, 120 in conjunction with each other and identify a number of different characteristics that may be much less apparent simply from reviewing the underlying numerical data. For example, in this clinical trial, there appear to be a significant number of AEs, which might cause concern that a potential issue with the treatment under study poses a safety risk to patients. However, the visualization indicates that most sites have a small AE rate, while a few sites seem to have an excessive number. Thus, a user analyzing these charts may conclude that, rather than there being a health risk posed by the drug in the trial, a few of the sites may be incorrectly dosing the patients, may be entering data incorrectly, or may otherwise be deviating from the trial protocol. Thus, the user may initiate action with respect to those specific sites rather than raising concern about the entire study. Thus, embodiments according to this disclosure may provide a richer understanding of characteristics of a clinical trial and allow for targeted corrective action as the trial occurs, rather than, after a trial has concluded, determining that some sites were not following the trial protocol and thus either that data must be discarded or the trial must be re-run.

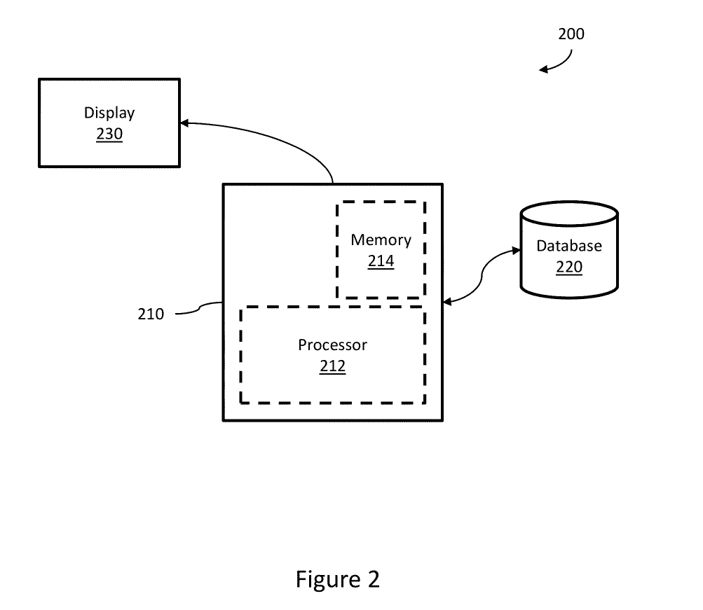

Referring now to FIG. 2, FIG. 2 shows a system 200 for data visualization according to one embodiment. The system 200 comprises a computer 210 having a processor 212 and a memory 214, and the processor 212 is in communication with the memory 214. In the embodiment shown in FIG. 2, the computer 210 is in communication with a database 220 and a display 230.

In the embodiment shown in FIG. 2, the computer 210 is configured to execute one or more software programs to provide data visualization. The computer 210 is configured to generate one or more display signals based on execution of the data visualization program(s) and to transmit those display signals to the display 230, which then displays data visualization, such as may be seen in FIG. 1A, and other information to a user. During execution of the one or more programs, the computers 210 is configured to transmit signals to the database 220 to request data from the database for use by the one or more programs. In some embodiments, the computer 210 may also be configured, or may be alternatively configured, to transmit one or more signals to the database 210 to save data to the database 220.

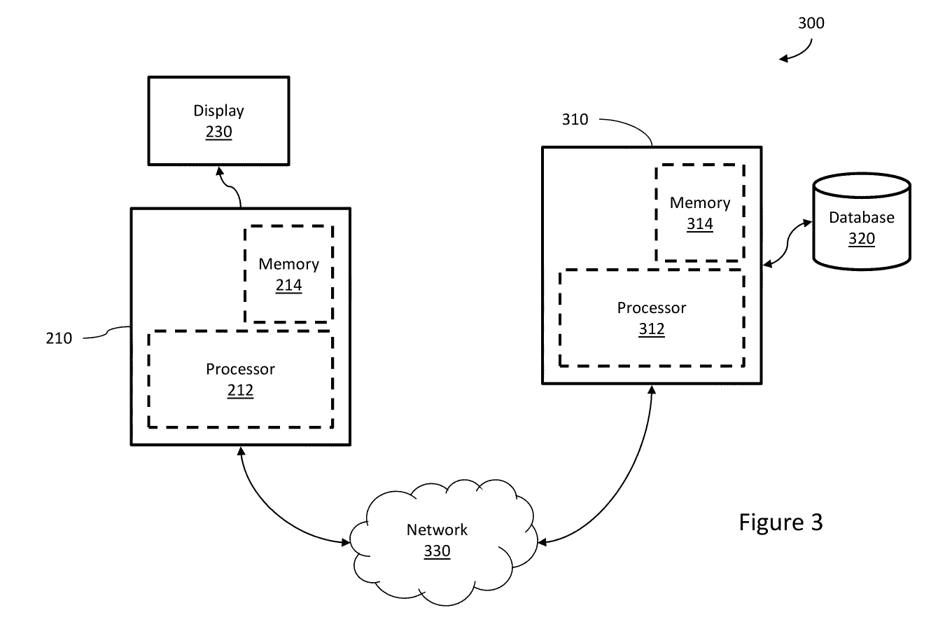

Another embodiment of a suitable system is shown in FIG. 3, which shows a system 300 comprising two computers 210, 310 that are in communication over a network 330. The first computer 210 comprises the computer shown in FIG. 2. The second computer 310 also comprises a processor 314 and a memory 312. In the embodiment shown in FIG. 3, the second computer 310 is in communication with a database 320. In addition, the first computer 210 is also in communication with the database 320 via the second computer 310. As described above with respect to FIG. 2, the first computer is in communication with a display 230.

In the embodiment shown in FIG. 3, the first computer 210 is employed by a user to execute one or more software programs for data visualization and to view data visualization on the display 230. The first computer 210 is configured to execute such software program(s) to request data from the database 320 by transmitting one or more signals across the network 330 to the second computer 310, which may then transmit signals to the database 320 to retrieve (or to save) data from the database. The first computer 210 receives the data from the second computer 310 via the network 330. The one or more software programs operate based at least in part on the data to generate one or more visualizations which may be encoded in one or more signals and transmitted to the display 230.

While in the embodiment shown in FIG. 3 the first computer 210 executes the one or more programs for data visualization, in some embodiments, software may be executed on the second 310 computer to perform such data visualization. In one such embodiment, a user accesses the first computer to use as a terminal to access software executed on the second computer 310. In some embodiments, software may executed on both computers 210, 310 to perform data visualization. In some embodiments a plurality of second computers 310 may be in communication over one or more networks and may be employed to provide a distributed system for data visualization.

In some embodiments, systems may provide data visualization based on data stored in one or more databases. For example, in one embodiment a computer 210 may be in communication with a plurality of databases. In this embodiment, each of the databases may store a particular type of data. For example, one database may store lab result data, a second database may store operational data, a third database may store EDC data. Thus, some embodiments according to the present disclosure may provide for data visualization across multiple different types of data and may provide a more unified view into disparate clinical trial data to provide analyses to provide a broader picture of the progress of a clinical trial and to address any issues as they arise or shortly after they have arisen.

### Study Indicators

Some embodiments according to the present disclosure employ SIs to generate visualizations of data and analysis relating to one or more clinical trials. SIs are metrics for analyzing clinical trial data. SI values may then be calculated from underlying clinical trial data based on the definitions of the respective SIs. SIs may be used for a variety of reasons, including aiding in identifying existing issues or preventing the occurrence of new issues. A SI is typically generated as a part of a business analysis to identify common or existing issues. Once an issue has been identified, clinical trial data is identified that may be analyzed to provide an indicator that an issue exists or that an issue may be forthcoming. For example, in one embodiment, a Failure Mode Effect Analysis (FMEA) tool set was employed to generate suitable SIs, and one or more thresholds for the SIs. To generate the SIs, in this embodiment, an end to end FMEA of study execution was performed to identify potential points of failure. For each identified point of failure, a SI was generated based on identified data that indicates a potential failure and also provides usable metrics for taking corrective action to potentially prevent such a failure

For example, a common occurrence in clinical trials is an “adverse event.” An adverse event is generally a side effect resulting from the use of a drug or therapy under testing during a clinical trial. For example, if a user is provided a dose of a drug and subsequently loses consciousness, the study location may record an adverse event. However, from an isolated occurrence, it is difficult to determine whether the adverse event resulted from the drug under test, or if some other factor or combination of factors resulted in the adverse event. For example, if the clinical study is testing the efficacy of an insulin substitute, the adverse event could have been a side effect of the substance or could have been triggered by an allergic reaction to the substance, i.e. potential issues with the substance itself. Alternatively, the adverse event could have been triggered by the patient's low blood sugar level and the study site's failure to check the patient's blood sugar before administering the substance, i.e. a procedural error.

By analyzing the occurrence of adverse events during a trial, it may be possible to identify issues with the drug that might warrant terminating the clinical trial prior to completion, such as if the occurrence of the adverse events indicates a significant issue with the drug being tested. Alternatively, it may be possible to identify procedural lapses or faulty data, which may indicate a problem with one or more clinical trial sites. Thus, by monitoring data during a clinical trial, it may be possible to identify and correct issues to minimize any impact to the quality of data generated during the clinical trial or, in some cases, to terminate a clinical trial early to prevent injury to test subjects, to revise ineffective test procedures, or to terminate a test of an ineffective drug.

While an adverse event relates to an occurrence at a particular visit and with respect to a particular subject during a clinical trial, SIs are not intended to be limited to events related to test subjects or data from a single visit. Rather, SIs may be employed to identify issues related to enrolling patients in a clinical trial, identify fraudulent or missing data, adulteration or inadequate dispensation of a drug, or other aspects of the performance of a clinical trial.

### Site-Level and Study-Level Thresholds

As will be described in greater detail below, in embodiments according to this disclosure, SI values may be calculated for one or more SIs. In some embodiments, thresholds may be defined for one or more SIs, which may then be used to identify potential issues within the clinical trial. For example, as was discussed earlier, a SI may generate data based on adverse event information. Calculated SI values may then be compared against one or more thresholds to identify potential issues or to generate indicators, such as visual indicators or other notifications, of the potential issues.

In some cases, a SI may have associated SI values that can provide insight into potential site-level issues or potential trial-level issues. Thus, thresholds may be set for SI values that represent data from individual sites and thresholds may be set for SI values, or data based on multiple SI values, that represent information about the entire trial.

Returning again to the illustrative example of the AE data discussed above, as AE data arrives from the various clinical trial sites, it may be compared to both site-level and trial-level thresholds. For example, in this illustrative embodiments, two site-level thresholds have been set: a ‘warning’ threshold and a ‘critical’ threshold. A warning threshold is set based on the mean number of AEs occurring at sites throughout a trial such that if an individual site reports a number of AEs that is more than 1 standard deviation greater than the mean, the warning threshold is met. The critical threshold is then set and reached if an individual site reports a number of AEs that is more than 2 standard deviations greater than the mean. In addition, the warning and critical thresholds may be set at 1 and 2 standard deviations less than the mean as well, such as to catch sites that are potentially under-reporting AEs.

The AE data may also be compared against trial-level thresholds. For example, in this embodiment, if more than 10% of sites have AE SI values more than 1 standard deviations from the mean (or have reached the ‘warning’ threshold) or more than 5% of sites have AE SI values more than 2 standard deviations from the mean (or have reached the ‘critical’ threshold), a trial-level ‘warning’ threshold may be triggered. In addition, a trial-level critical threshold may be reached if more than 20% of sites have AE SI values more than 1 standard deviations from the mean (or have reached the ‘warning’ threshold) or more than 10% of sites have AE SI values more than 2 standard deviations from the mean (or have reached the ‘critical’ threshold).

Other thresholds may be set as well, or instead. For example, if the standard deviation exceeds a value that is 20% of the mean, a threshold may be reached, potentially indicating very wide variance in the occurrence of AEs throughout the trial. Still other thresholds may be set, at either the site or trial level, or both.

As was discussed above, SIs may be defined and used to monitor the status of a clinical trial. Further, a number of SIs have been developed for use with one or more embodiments according to the present disclosure. The following are 29 example SIs that may be advantageously employed in one or more embodiments according to the present disclosure.

### Acronyms

A number of acronyms are used throughout this disclosure. The following table provides explanations of many of these acronyms:

| Acronym | Term |
|---|---|
| AE | Adverse Event |
| CRA | Clinical Research Associate |
| FPI | First Patient In |
| FPR | First Patient Randomized |
| IMP | Investigational Medicinal Product |
| SAE | Serious Adverse Event |
| SD (or σ) | Standard Deviation |
| SI | Study Indicator |
| SIV | Site Initiation Visit |

### SI: Adverse Event Trends

As discussed above, adverse events may occur during a clinical trial and may indicate a problem with a treatment under trial, the trial procedure itself, or errors occurring at trial sites. Because adverse events can result in risk to a study participant, identifying potential trends of adverse events may be important when managing a clinical trial. Thus an adverse event trends (AET) SI has been developed.

In one embodiment, data regarding adverse events at one or more trial sites is received and recorded. A mean number of adverse events for each randomized patient at each site is calculated, and a mean number of adverse events for each randomized patient for the entire trial is calculated. After these values have been calculated, the mean for each site is compared against the study mean. As described with respect to other SIs, one or more thresholds may be used to generate one or more indicators based on the difference between the mean for each site and the study mean. For example, in one embodiment, only one threshold is used for each site. In such an embodiment, the threshold may be reached when the mean for a site is greater than or equal to twice the study mean. In another embodiment, a second threshold may be set for when the mean for a site is greater than or equal to 50% greater than the study mean. When the first or second threshold is reached, one or more indicators may be generated.

In addition to identifying sites with elevated adverse event rates, a study-level SI value may be calculated. For example, in one embodiment, two study-level thresholds may be established. The first threshold may be reached when 5% or more sites have adverse event rates at or greater than twice the study mean, while the second threshold may be reached when 10% or more sites have adverse event rates at or greater than twice the study mean. After the study-level AET SI value is determined and if the first or second threshold is reached, one or more indicators may be generated.

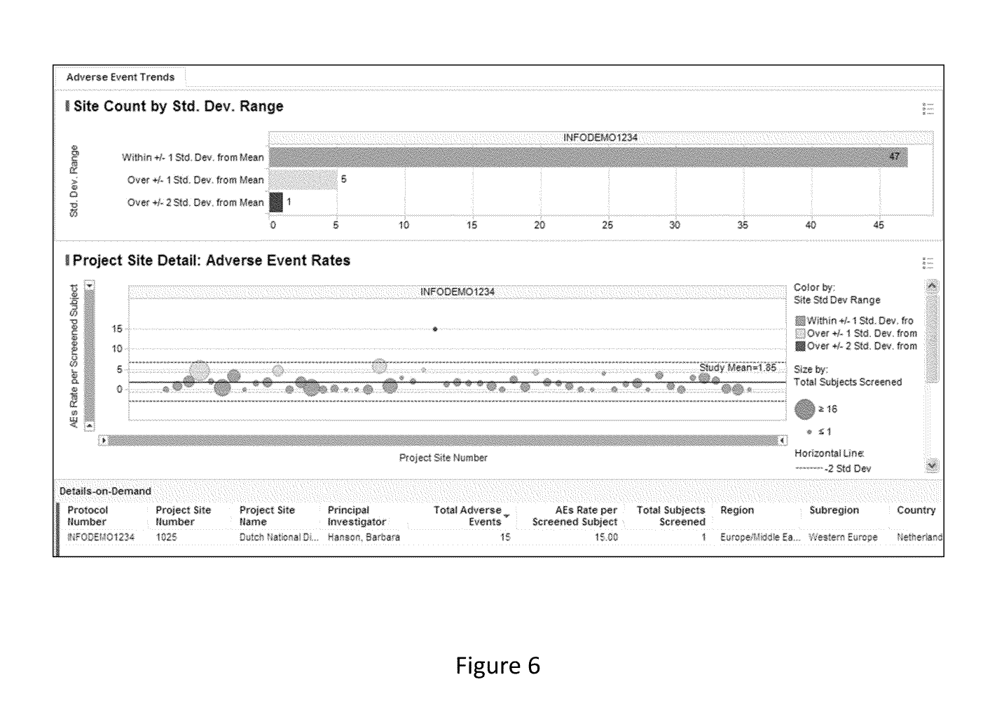

In one embodiment, a system for data visualization generates and displays a visualization of the AET SI. For example, FIG. 6 shows a visualization for the AET SI according to one embodiment. In the embodiment shown, a system for data visualization displays a plurality of graphical indicators representing adverse events for the study and for individual sites. In the bar chart, aggregated site data is displayed showing the number of sites reporting adverse event data within two defined thresholds—less than 1 standard deviation from the mean for the study and less than 2 standard deviations from the mean for the study—which results in three ranges as can be seen.

In addition to the study-level visualization, the visualization in FIG. 6 provides a site-level graphical visualization. The site-level visualization includes a two-dimensional plot showing adverse event rates with respect to the study mean. Sites within the study are represented within the plot by circles with radii indicating the number of subjects screened at the site. A circle's position within the vertical axis indicates the corresponding sites performance relative to the study mean, as does the color of the circle. In addition, horizontal indicator lines are provided to show the two site-level thresholds for this SI in this embodiment. Thus, a user viewing the site-level information may quickly and intuitively identify sites that have high rates of adverse events and implement corrective actions when appropriate.

In some embodiments, a user may take corrective action based on visualization information. For example, in one embodiment, a user may identify one or more sites with AE rates exceeding the first or second threshold for corrective action. The user then contacts one or more CRAs assigned to such identified sites to identify potential causes and to cause the CRA to discuss AE trends during a subsequent site visit. Following the subsequent site visit, the user reexamines the site to determine whether the rate of AEs has improved.

### SI: FPI to First Monitoring Visit

A FPI to First Monitoring Visit (FFMV) SI has been developed to help track the rate at which clinical trial sites are reviewed by a CRA for compliance with the clinical trial.

As clinical trial sites are established and begin working with patients, a CRA is scheduled to visit each new clinical trial site to determine compliance with the procedures of the clinical trial. In one embodiment, as a new clinical trial site becomes active and has its first patient visit (FPI or “first patient in”) or its first patient randomized (“FPR”), data regarding the time when a CRA first visited the new clinical trial site is logged and used to determine whether the CRA visit was made in a timely fashion. To compute the SI value, a system according to one embodiment calculates the number of clinical trial sites at which the first monitoring visit occurred more than 10 days after FPI or FPR as a percentage of the total number of clinical trial sites. If the percentage is between 5-10%, a first indicator is generated, while if the percentage is greater than 10%, a second indicator is generated.

In one embodiment, a system for data visualization generates and displays a visualization of the FFMV SI. In addition to providing a visualization of the FFMV SI, in one embodiment, a user may be able to select a particular site to obtain more detailed information. A user may select a particular site, which may be displayed as amber (or orange) if the delay following FPI until a CRA visit was between 10-20 days, or as red if the delay following FPI until a CRA visit, if one has occurred, is greater than 20 days. Thus, a user of the system may be able to quickly determine, at a study level, whether appropriate monitoring visits are occurring with sufficient regularity and, for particular sites, may be able to determine whether the delay was minimal (e.g. 11 days) or significant (e.g. more than 20 days).

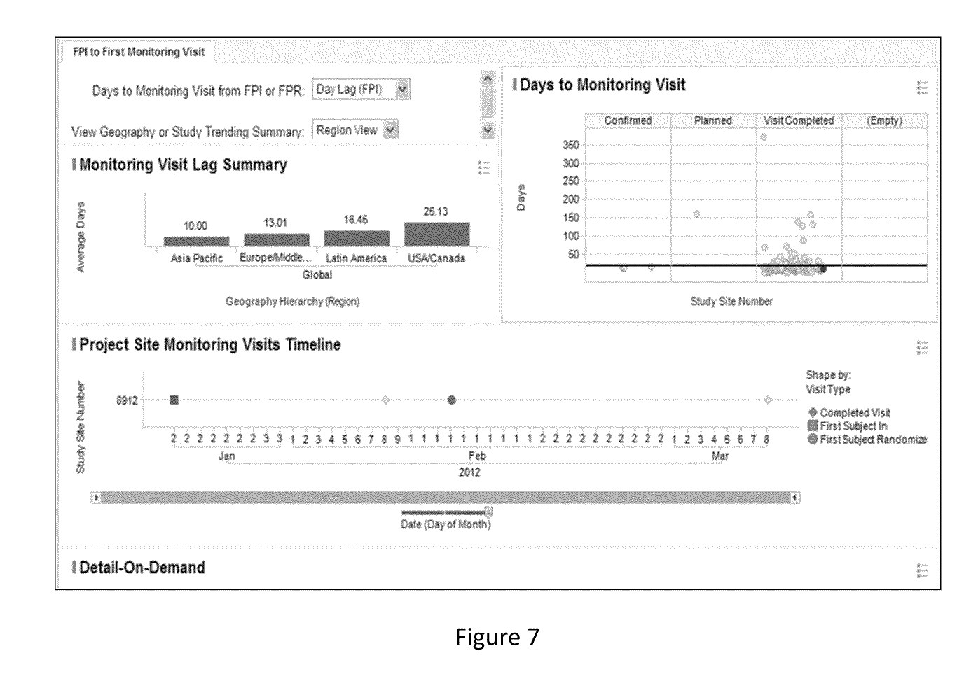

In one embodiment, a system for data visualization generates and displays a visualization of the FFMV SI. For example, FIG. 7 shows a visualization of the FFMV SI according to one embodiment. In the embodiment shown in FIG. 7, three graphical visualizations are provided. The first provides a bar chart showing average days to a first monitoring visit for different regions within the study. Such a view is configurable by selecting from the two drop down menus provided in this embodiment. For example, a user may select other parameters on which to aggregate and view the data, such as by country or by FPR.

The embodiment in FIG. 7 also includes a two-dimensional plot showing the time to first visit for each site as well as whether the visit has been confirmed, planned, or completed. For each site, a point is displayed within the plot area to indicate the number of days to the first monitoring visit such the that the vertical position of a point indicates the delay for a particular site and the relative positioning of the various points can indicate potential outlier sites. In addition, an indicator line is provided in this embodiment to show a threshold, thus allowing a user to easily identify sites that have exceeded the monitoring visit lag.

The third visualization provided in the embodiment of FIG. 7 is a timeline showing visit and patient events for one or more sites in a study. For example, a user may select one or more of the sites within the two-dimensional plot for closer examination. In this embodiment, site 8912 has been selected. The timeline in this embodiment shows FSI and FSR events and completed visit events. As can be seen, the FPI event occurred on about January 23, with the visit occurring 16 days later on February 8. The FPR then occurred on February 13, with the subsequent visit occurring 29 days later on March 8.

According to various embodiments, a user may be able to use the visualization information to identify sites having significant delays and identify potential issues that cause delays in scheduling and completing visits. For example, a user may identify one or more sites where an FPI or FPR event has occurred, but no visit has been completed after the 10 days threshold. The user may then determine whether a visit has been scheduled, and if not, contact a CRA to schedule a visit. In one embodiment, the user may determine that a number of CRAs assigned to the study is insufficient to schedule visits within a desired time frame and contact a study administrator to discuss the addition of one or more additional CRAs.

### SI: Site Inactivity

In a clinical trial, one or more sites may experience low or no patient activity, which may indicate that there is an issue with the site or that the site simply has very few, if any, patents enrolled in the study. The SI developed for this metric is referred to as a Site Inactivity (SI) Study Indicator.

Data relevant to this SI includes the number of days elapsed since the last enrolled patient was screened at a particular site within the study and the expected screening time (EST) for the study. In one embodiment, the Site Inactivity SI uses five thresholds to specify six ranges: (1) less than 0.4 times the EST (very recent activity), (2) less than 0.8 times the EST (recently active), (3) less than 1.2 times the EST (expected average), (4) less than 1.6 times the EST (slightly beyond expected), (5) less than 2.0 times the EST (significantly beyond expected). A value greater than or equal to 2.0 is interpreted, in this embodiment, as highly inactive. Using these thresholds, each site may be classified according to its respective patient activity. In one embodiment, the number of sites within each range may then be compared against one or more thresholds to provide an indicator regarding study-level site activity.

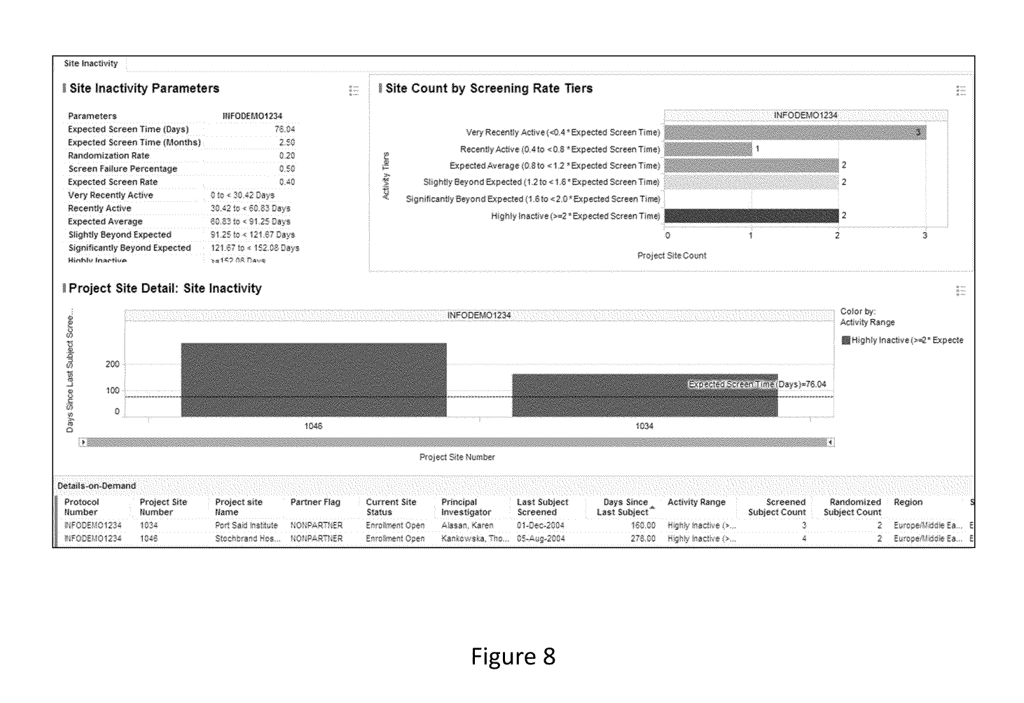

In this embodiment, a visualization related to the Site Inactivity SI is shown in FIG. 8. As may be seen in the visualization, three visualization windows are shown: the first shows a plurality of site inactivity parameters, including the EST, shown as both a number of days and the number of months. The thresholds according to this embodiment are shown. For example, the “very recently active” threshold of 0.4 times the EST is shown as 30.42 days, which is 0.4 times the EST of 76.04 days. In addition to the thresholds, visual information is shown for an operator that allows for easy identification of potential issues and a visualization that allows the user to drill down into the data. For example, FIG. 8 shows a bar chart corresponding to each of the 6 ranges defined by the 5 thresholds, which shows 2 sites in the study falling into the “slightly beyond expected” range and 2 sites falling into the “highly inactive” range. FIG. 8 shows an additional visualization that was generated responsive to the user selecting the “highly inactive” range. The additional visualization shows data for the two “highly inactive” sites, which includes the number of days since the last patient was screened: site 1046 has not screened a patient in 278 days and site 1034 has not screened a patient in 160 days, and a bar chart providing a graphical representation of the number of days since the last patient was screened.

After a user has identified sites for deeper analysis, such as by selecting one or more sites falling into one of ranges 4-6 in this embodiment, the user may identify a course of action to reduce potential risks to the quality of the clinical trial. For example, the user may contact the site to identify strategies for increasing recruitments, or recommend to the study administration to add one or more additional clinical trial sites.

### SI: High Enrollment

In a clinical trial, a number of different site locations will participate by enrolling patients in the trial, administering drugs, recording data, or other services. Because these sites are typically located in areas having different demographics and population densities, different sites will tend to enroll different numbers of people. However, if a site is enrolling patients at a substantially higher rate than other sites, it may indicate potentially unwanted behavior, such as lax standards or simple fraud. Thus, increased scrutiny of high-enrolling sites may be desired and a High Enrollment (HE) SI has been developed to identify such sites.

In one embodiment, a patient enrollment rate is calculated for each site participating within a clinical trial. Subsequently, a mean patient enrollment is calculated. In this embodiment, a study-level HE SI percentage is calculated based on the number of sites that report a patient enrollment rate that is two standard deviations greater than the mean patient enrollment rate for the study and the total number of sites. In this embodiment, two thresholds are pre-determined for the study-level HE SI. The first threshold is reached when the study-level HE SI percentage reaches 20% of the total sites, and the second threshold is reached when the study level HE SI percentage reaches 30% of the total sites.

In addition to study-level thresholds, or instead of study-level thresholds, some embodiments may employ site level thresholds. For example, in one embodiment, two site-level thresholds are employed. A first threshold is reached when a site's enrollment rate reaches or exceeds two standard deviations above the mean patient enrollment rate for the study, while a second threshold is reached when a site's enrollment rate reaches or exceeds three standard deviations above the mean patient enrollment rate for the study.

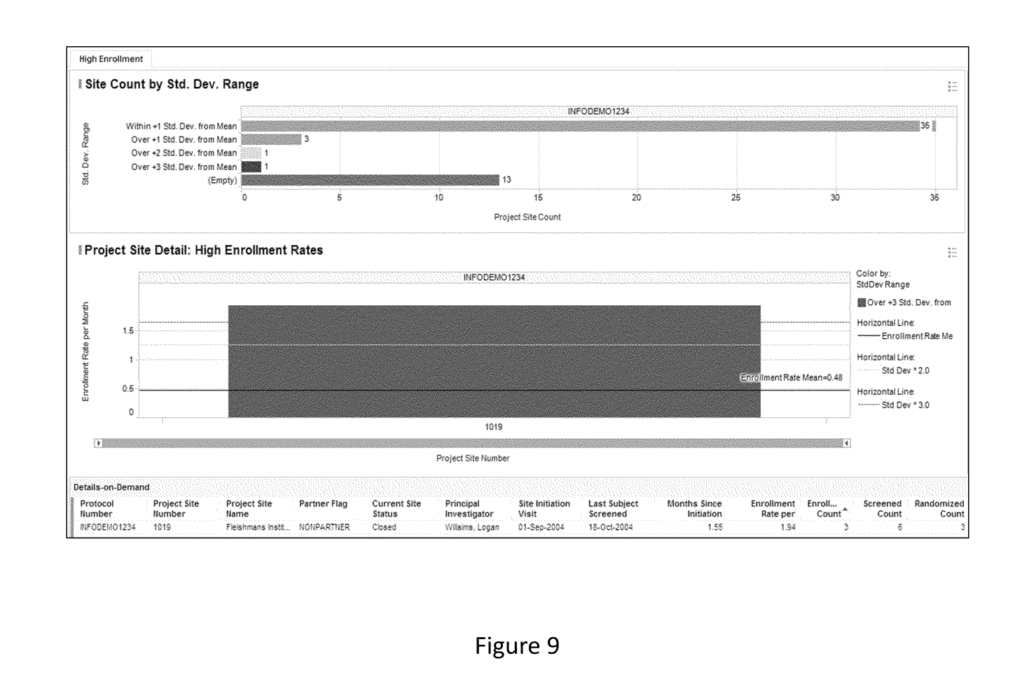

In one embodiment, a system for data visualization generates and displays a visualization of the HE SI. For example, FIG. 9 shows a visualization of the HE SI according to one embodiment. In the embodiment shown in FIG. 9, two graphical visualizations are provided. The first graphical visualization comprises a study-level bar chart showing the number of sites exceeding a particular threshold. In this embodiment, 2 thresholds have been set at 2 and 3 SDs from the mean. According to these thresholds, this visualization shows that 38 sites are below the first threshold, 1 site is between 2 and 3 SDs from the mean, and 1 site is more than 3 SDs from the mean. Finally, 13 sites are shown as having no enrolled patients.

In addition to the study-level visualization, a site-level visualization is provided as well. In this embodiment, a user may select one or more sites for viewing within the site-level visualization. As may be seen in FIG. 9, the site-level visualization shows data for a single site: 1019. As may be seen, the site's enrollment rate is more than 3 standard deviations from the study mean and thus is displayed in a red color. In addition, the bar exceeds each of the two defined thresholds, which are represented by horizontal indicators. In this embodiment, a site's bar is colored according to which threshold it exceeds. For example, a site that exceeds only the first threshold is colored yellow or amber, while a site that does not exceed any threshold is colored green. In addition to the visualizations, summary data is provided in a table for the selected site, such as the site's enrollment rate.

In some embodiments, a user may take corrective action based on information provided by one or more visualizations. For example, a user may identify one or more sites with significant enrollment rates and retrieve and examine associated visit records associated with the identified sites. The user may then contact a CRA or similar person to discuss additional corrective actions and to contact the site to schedule a visit. In some embodiments, the user may determine that high enrollment for the site is normal and thus may take alternative actions, such as allocating additional resources to the site to accommodate the increased number of patients. In addition, the user or the CRA may prepare and store documentation associated with the site to identify identified issues and corrective action taken.

### SI: Site Initiation Visit (SIV) to FPI; SIV to FPR

When starting up a new site for use in a clinical trial, there is a time lag between when the site itself is ‘initiated’ into the clinical trial and when the site enrolls its first patient into the trial. This time lag can be used to assist in projecting site and patient recruitment needs, and time until the first patients are randomized within the trial. Thus, an SIV to SPR SI and an SIV to FPI SI has been created to assist with this analysis.

In one embodiment, as sites are included within the clinical trial, data is tracked for each to determine the time between the site initiation visit and the first patient is enrolled in the trial and the first patient randomized at the site. As the data is gathered, a visualization may be generated that shows the various SIV to FPI and SIV to FPR values for each site according to a “tier.” For example, in this embodiment, a first tier represents all sites that have an SIV to FPI or SIV to FPR value from 0 to the mean value less one standard deviation of the mean, a second tier represents all sites that have an SIV to FPI or SIV to FPR value between the mean value less one standard deviation of the mean and the mean, a third tier represents all sites that have an SIV to FPI or SIV to FPR value between the mean and the mean plus one standard deviation, and a fourth tier represents all sites that have an SIV to FPI or SIV to FPR value greater than the mean plus one standard deviation.

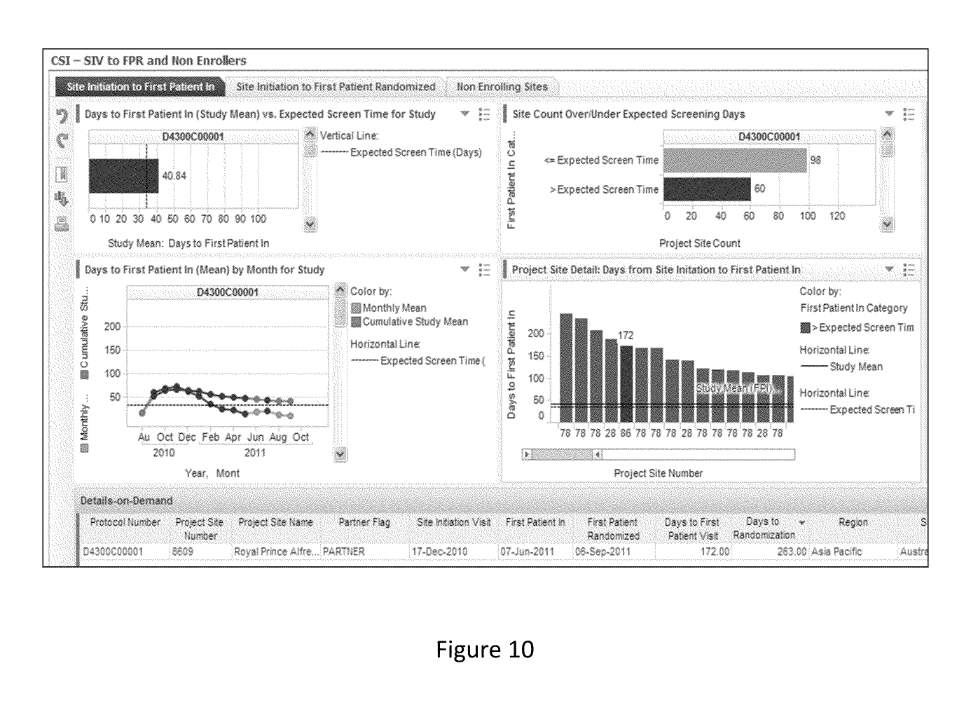

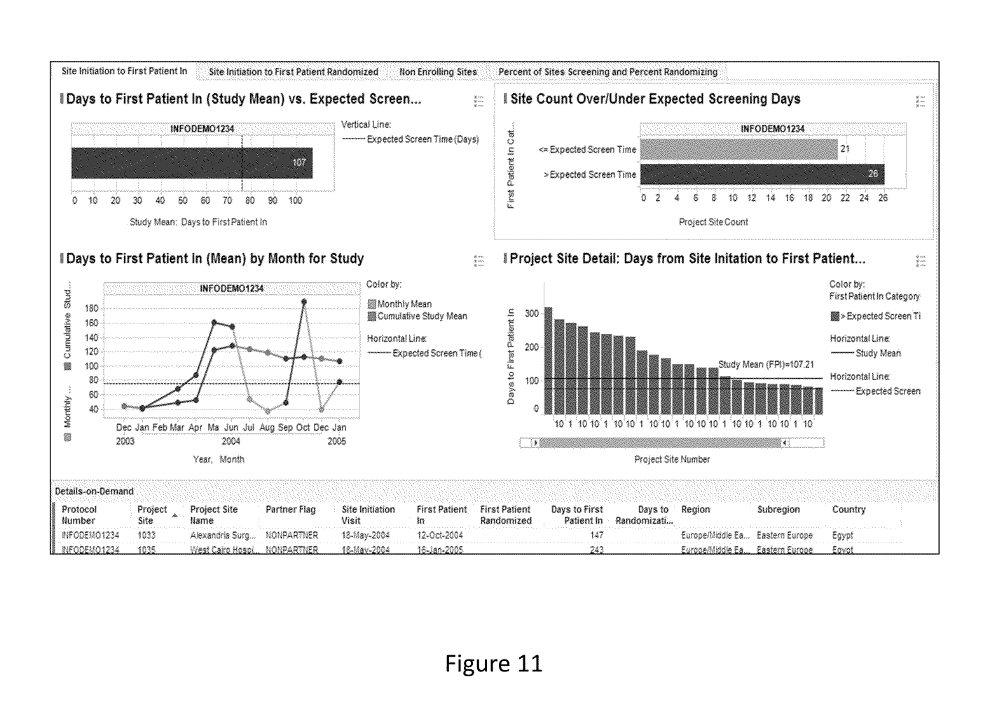

In one embodiment, a system for data visualization generates and displays a visualization of the SIV to FPI SI or the or SIV to FPR SI. For example, FIGS. 10 and 11 show embodiments of visualizations of the SIV to FPR SI and the SIV to FPI SI, respectively. In the embodiment shown in FIG. 10, a user is presented with 4 graphical visualizations of SIV to FPR data and a table with numerical data. The user is presented with a visualization of the study mean for a first patient randomized and an indicator of the expected screen time overlaid on the study mean bar chart. In addition, the user is presented with a bar chart showing the cumulative number of sites that have met the expected screen time (98 sites) and the cumulative number of sites that have exceeded the expected screen time (60 sites). A user may select one or both of these bars to be provided with more detailed information regarding the individual sites represented by the aggregate data. The user is also presented with a data plot showing the change in the number of days from SIV to FPR from month to month over a user-selected timeframe. Each of the data points on the plot may be selected to retrieve more detailed data for a particular month.

In this embodiment, the visualization also includes a bar chart showing project site detail, which shows the number of days from site initiation to first patient randomization. The bar chart shows data for each project site, along with a corresponding site number to identify each site, as well as the actual study mean for SIV to FPR and the expected time for SIV to FPR. Numerical data corresponding to the bars in this chart is displayed in a table as can be seen in the ‘Details-on-Demand’ table, including the numerical value for each site's SIV to FPR value.

As may be seen in FIG. 11, in this embodiment similar data visualizations are provided for the SIV to FPI SI as were provided in FIG. 10. For example, each of the four graphical visualizations are provided in this representation, though the underlying data is different given that different data is analyzed.

After obtaining the visualized information, a user may identify one or more sites for which corrective action may be appropriate. For the SIV to FPR SI, the user may also access data relevant to the Non Enrollers SI (described below) and the SIV to FPI SI. In this embodiment, a user then identifies potential corrective actions. For example, the user may determine that additional sites may be needed, that additional patients should be enrolled for randomizing sites, or that a CRA should visit the site.

### SI: Screen Failure Rates and Reasons

A Screen Failure Rates and Reasons (SFRR) SI has been developed to help track the rate at which patients fail to qualify to receive investigational product.

During a clinical trial, patients are screened for suitability to participate within the clinical trial. When new candidate patients are screened, certain patient characteristics may cause the patient to be unsuitable for use within a clinical trial. It may be of value to be presented with a visualization of a trend of patient screen failure rates. To calculate screen failure rates, the number of patients that have failed the screen process is divided by the total of number of patients that have completed the screen process. Note that in this embodiment, the calculation excludes patients who are in the midst of the screening process. In various embodiments, screen failure rates may be determined for predetermined time periods, such as monthly. In addition, in some embodiments, screen failure rates may be determined separately for each site. Thus, it may be possible to compare the relative performance of different sites for a particular period of time.

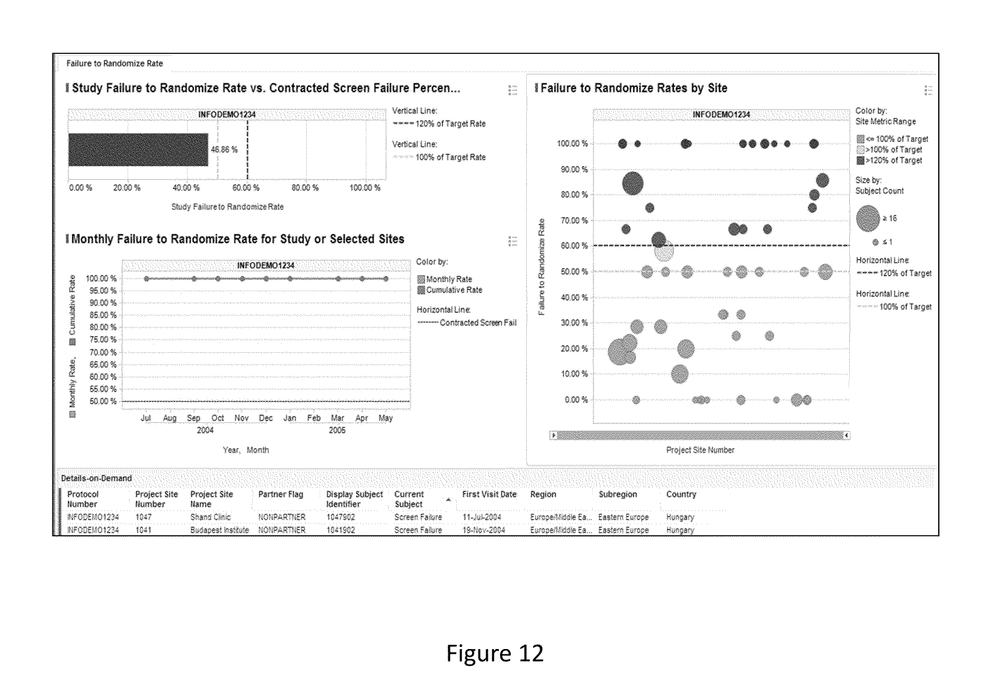

In one embodiment, a system for data visualization generates and displays a visualization of the SFRR SI, which may also include reasons why one or more of patients failed the screening process. FIG. 12 shows a data visualization for the SFRR SI according to one embodiment. In the embodiment shown in FIG. 12, three graphical visualizations are shown as well as a table having numerical data. A first graphical visualization shows a measured screen failure rate for the study as well as two threshold indicators. The first threshold indicator corresponds to a first study-level threshold of 100% of the target screen failure rate, while the second threshold indicator corresponds to a second study-level threshold of 120% of the target screen failure rate. As can be seen in FIG. 12, the measured screen failure rate is below the first threshold in this embodiment.

A second graphical visualization is shown comprising a data plot that shows a plurality of circles arrayed over a two-dimensional plot area. As may be seen in the legend area of the plot, the radius of each circle indicates the number of subjects screened at a particular site, while the color of a circle indicates the site's performance relative to the SFRR SI site-level thresholds.

In this embodiment, the plot area also comprises indicators for two site-level thresholds, which are shown as hashed lines extending across the plot area. The first threshold indicator corresponds to a first site-level threshold of 100% of the target screen failure rate, while the second threshold indicator corresponds to a second site-level threshold of 120% of the target screen failure rate. As can be seen, a circle's position on the graph also provides a visual indication of the sites performance relative to the two site-level thresholds.

Finally, the embodiment in FIG. 12 includes a third plot that shows performance of the overall study, or for one or more selected sites, relative to the SFRR SI. In this embodiment, the selected site has rejected every candidate patient and thus may be identified for follow up to correct a potential problem with the screening process at the site.

After reviewing the visualization shown in FIG. 12, a user may identify one or more sites for corrective action. For example, the user may identify a site with a SFRR SI value that exceeds the second site-level threshold and contact trial Monitor or the site itself. In some embodiments, the user may analyze rejection criteria and identify potential changes to the criteria, such as criteria that reflect inaccurate expectations. In some embodiments, a user may identify a site that meets each of the two site-level thresholds, but appears to be an outlier, for additional analysis, such as for identifying potential corrective action as described above.

### SI: Non-Enrollers

In a clinical trial, one or more sites may not enroll patients, or may enroll them at a very slow rate. Thus, it may be desirable to add additional sites to the study to increase the number of patients participating in the trial, or to close sites to reduce costs associated with the trial. Thus, a Non-Enrollers (NE) SI has been developed to assist clinical trial staff to identify non-enrolling sites during the trial to allow corrective action to be taken quickly.

In one embodiment, data regarding a site's activation and enrollment is received. For example, the date of a site's initiation visit and the date of the first patient enrolled at the site may be used to determine sites with potential enrollment problems. The difference in time between the SIV and the FPI or FPR may be calculated and compared to one or more thresholds. For example, in this embodiment, three site-level thresholds have been established at 88, 174, and 260 days, though other embodiments may employ a different number of thresholds, or different thresholds.

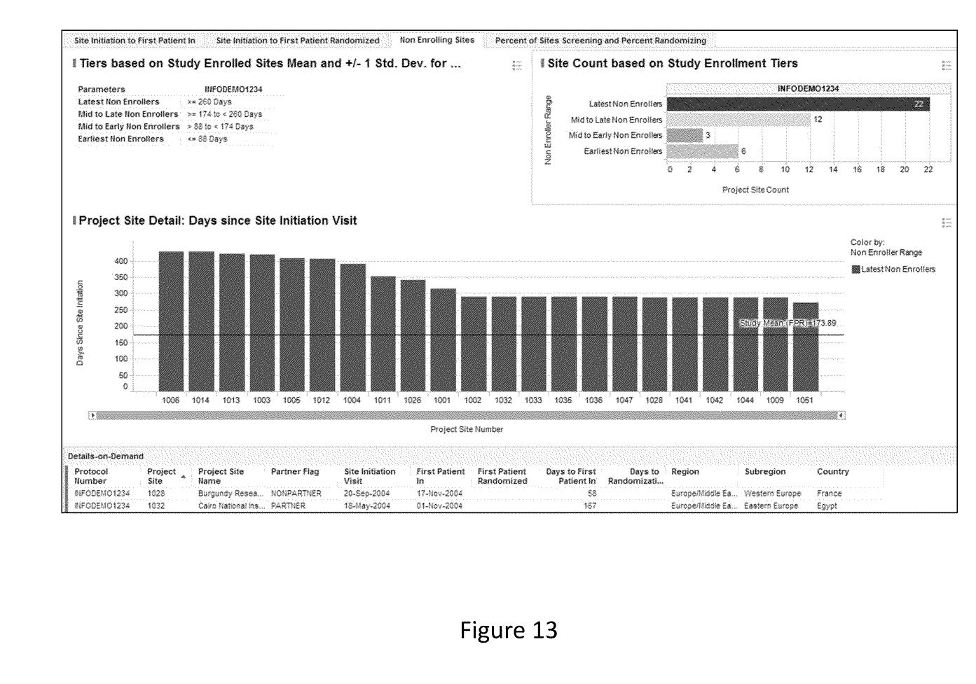

In embodiments according to this disclosure, a system for data visualization may generate and display a visualization of the NE SI. For example, FIG. 13 shows a visualization according to one embodiment. In the embodiment shown, the system displays the various ranges for the NE SI based on thresholds set for the SI. In this embodiment, three site-level thresholds have been established at 88, 174, and 260 days. A study-level visualization is provided in this embodiment as a colored bar graph. The study-level visualization comprises a plurality of bars, each corresponding to a range between threshold values. As can be seen the ranges have been provided with labels, such as “Mid to Late Non Enrollers” corresponding to the range between the second and third thresholds. The bar graph provides a visualization of the number of sites falling into each of the ranges. In this case a majority of sites is located within the range that exceeds the third or highest threshold value.

The embodiment shown in FIG. 13 also includes a site-level visualization. The site-level visualization comprises a bar graph showing the number of days since a SIV for each selected site. In the embodiment shown, a user has selected all sites falling within the range that exceeds the third or highest threshold value. As can be seen, the site-level visualization provides a sorted arrangement of the sites within the selected range based on the number of days since the SIV for the respective site. In addition, the site-level visualization provides a graphical indicator of the study mean to allow a user to quickly identify both relative performance between different sites, but also with respect to the study as a whole. This embodiment also provides a summary table showing information regarding one or more selected sites, such as the days from SIV to FPI and the dates of both the SIV and the FPI events.

In some embodiments, a user may employ the visualization information to identify potential issues and take corrective action. For example, in this embodiment, a user may take corrective action based on one or more thresholds. For example, if a site does not exceed the first threshold, a user may take no action with respect to the site. If a site exceeds the first threshold, but not the second threshold, the user may contact a CRA or other personnel and contact the site. If a site exceeds the second threshold, but not the third threshold, the user may initiate a letter to the site to spur the site to increase recruitment of patients. And if a site exceeds the third threshold, the user may recommend that the site be closed. In other embodiments, different corrective actions may be taken based on particular study parameters and thresholds.

### SI: Critical Documents

As a part of initiating a clinical trial, a significant number of documents must be generated and finalized by the customer, or sponsor of the trial. While many of these documents are timely generated; however, if a few critical documents are delayed, it can substantially delay the initiation of the clinical trial. Thus, a critical documents (CD) SI has been developed.

In one embodiment, a pool of documents must be generated by the sponsor of the trial. One or more of these documents is identified as being a critical document. For example, a final protocol document may generally be flagged as a critical document. For one or more of these critical documents, a target completion date for the critical document is received. Over time, a projected completion date, which may change, is received. The projected completion date is then compared against the target completion date and the difference is determined. The difference may then be compared against one or more threshold values. For example, in one embodiment, a threshold of 7 days may be set such that a difference that is greater than 7 will be identified as a potential issue. In addition, one or more study-level thresholds may be defined, such as based on a percentage of sites within the study that exceed one or more threshold values. For example, in one embodiment, a study-level threshold may be set at 20%, such that if more than 20% of sites exceed the site-level threshold, a study-level indicator is generated.

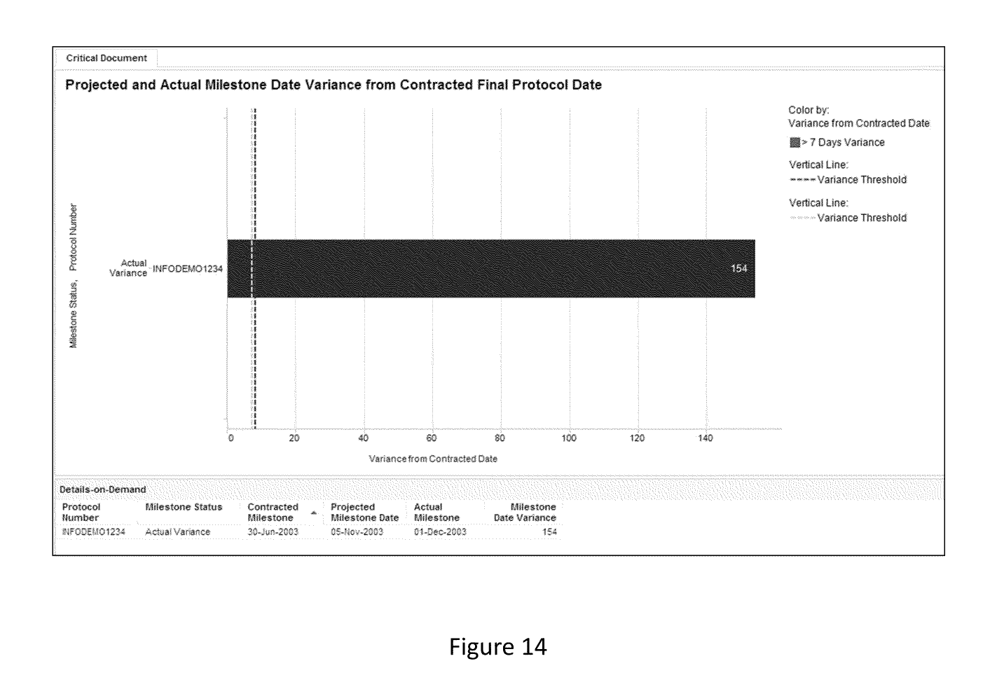

In one embodiment, a system for data visualization generates and displays a visualization of the CD SI. FIG. 14 shows a visualization according to one embodiment. In the embodiment shown in FIG. 1, a system provides a graphical visualization showing a bar chart showing status of a protocol in a clinical study. In the visualization shown, the bar represents the number of days between the target completion date and the actual completion date. In this embodiment, if the actual completion date is available, it is used in lieu of the projected completion date, though in some embodiments, multiple bars may be displayed, one corresponding to the difference between the target and projected completion dates, one for the difference between the target and actual completion dates, and one showing the difference between the projected and actual completion dates. In addition to the bar, the visualization also provides an indicator of the target date and the first threshold of 7 days in this embodiment.

Using information provided by data visualizations, a user may identify one or more protocols that has been delayed in being prepared. For example, a user may view a visualization providing a graphical indication of the status of a plurality of CS SIs. In such an embodiment, the user may be able to identify CDs that are nearing a target completion date or that have exceeded the allowed variance from the completion date. Thus, a user may be able to quickly identify CDs that may require immediate attention or attention in the near term. For example, a user may identify a CD that has a projected completion date that exceeds a variance threshold from the target completion date. The user may then contact the project sponsor to identify the schedule slip and to discuss impact of the change in schedule on the clinical trial, including bonus or penalty milestones. In some embodiments, the user may

### SI: Site Selection

During the process of managing a clinical trial, various trial sites will be contracted and opened for enrolling patients in the trial. However, prior to contracting, potential sites must be selected for inclusion within the study and the rate at which potential sites are selected can affect the smooth performance of the trial. Thus, as a part of this process, targets may be set for the number of new sites to be selected as a part of a trial over a certain time period or by certain milestones. It may be helpful to determine whether the rate of site selection achieves such targets. Thus, Site Selection (SSEL) SI has been developed.

In one embodiment, a target number of sites to be selected for a period of time (one month in this embodiment) is received. At the conclusion of the month, the actual number of sites selected is compared against the target. The ratio is then compared against one or more thresholds to determine whether a sufficient number of sites has been selected or whether one or more indicators should be generated. For example, in this embodiment, two study-level metrics are used. The first threshold is reached if the number of sites selected is less than the target value, and the second threshold is reached if the number of sites selected is less than 80% of the target value.

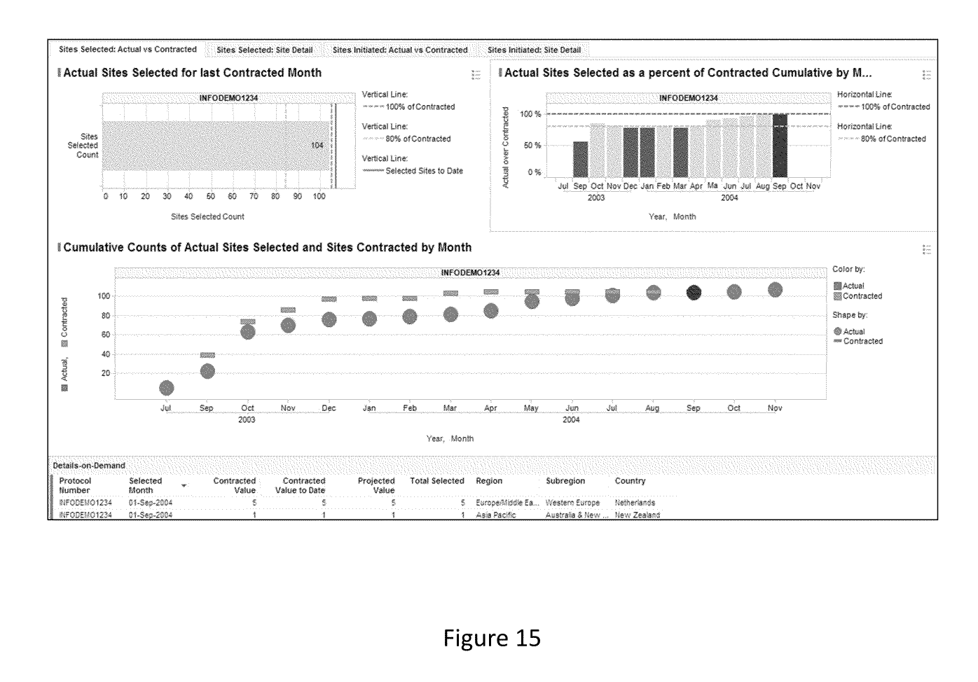

In one embodiment, a system for data visualization generates and displays a visualization of the SSEL SI. For example, FIG. 15 shows a visualization of the SSEL SI according to one embodiment. In the embodiment shown in FIG. 15, the system presents several graphical visualizations to a user. The first shows a study-level visualization of the number of sites selected within the last month. In addition, this visualization includes graphical indicators of two thresholds, such as those described above. In this embodiment, the first threshold is set at 100% of a target value and the second threshold is set at 80% of a target value. While it may not be apparent from the single bar on the graph, the bar may be color-coded based on the respective threshold it exceeds. In the embodiment shown in FIG. 15, the bar has a yellow, or amber, color to indicate that the number of site initiations is between the first and second thresholds. If the number of site initiations was above the first, this embodiment would display a green-colored bar, while if the number of site initiations was less than the second threshold, the bar would have a red color in this embodiment.

The system also provides a second graphical, study-level visualization that shows the number of sites selected as a percent of the cumulative number contracted on a month-to-month basis. As before, this second visualization provides graphical indicators of the two thresholds. The graphical indicators can provide easy, intuitive markers to allow a user to quickly determine when data values fall outside of desired ranges.

The system provides a third, study-level visualization that shows the actual and projected number of sites selected and the number of sites contracted on a per-month basis. As can be seen this visualization provides an intuitive display of trends for the number of sites targeted to be selected, and the actual number contracted. Thus, a user may quickly see how site selection has progressed and may be able to identify potential issues based on the visible trends.

In addition to providing visualizations, the system may allow a user to take corrective action based on one or more of the visualizations. For example, if the user determines that site selection is proceeding as expected, she may drill down into the data, such as on a region-by-region basis, rather than at the study level, to ensure that each region is enjoying similar success. If a user identifies potential issues, whether at the study level, the region level, or at another level, the user may contact one or more CRAs or other personnel to determine whether sites will be selected as scheduled or whether there are particular site selection issues to be addressed.

### SI: Site Initiation

During the process of managing a clinical trial, various trial sites will be contracted and opened for enrolling patients in the trial. As a part of this process, targets may be set for the number of new sites to be initiated as a part of a trial over a certain time period or by certain milestones. It may be helpful to determine whether the rate of site initiations achieves such targets. Thus, an Site Initiation (SINIT) SINIT has been developed.

In one embodiment, a target number of sites to be initiated for a period of time (one month in this embodiment) is received. At the conclusion of the month, the actual number of sites initiated is compared against the target. The ratio is then compared against one or more thresholds to determine whether a sufficient number of sites has been initiated or whether one or more indicators should be generated. For example, in this embodiment, two study-level metrics are used. The first threshold is reached if the number of sites initiated is less than the target value, and the second threshold is reached if the number of sites initiated is less than 80% of the target value.

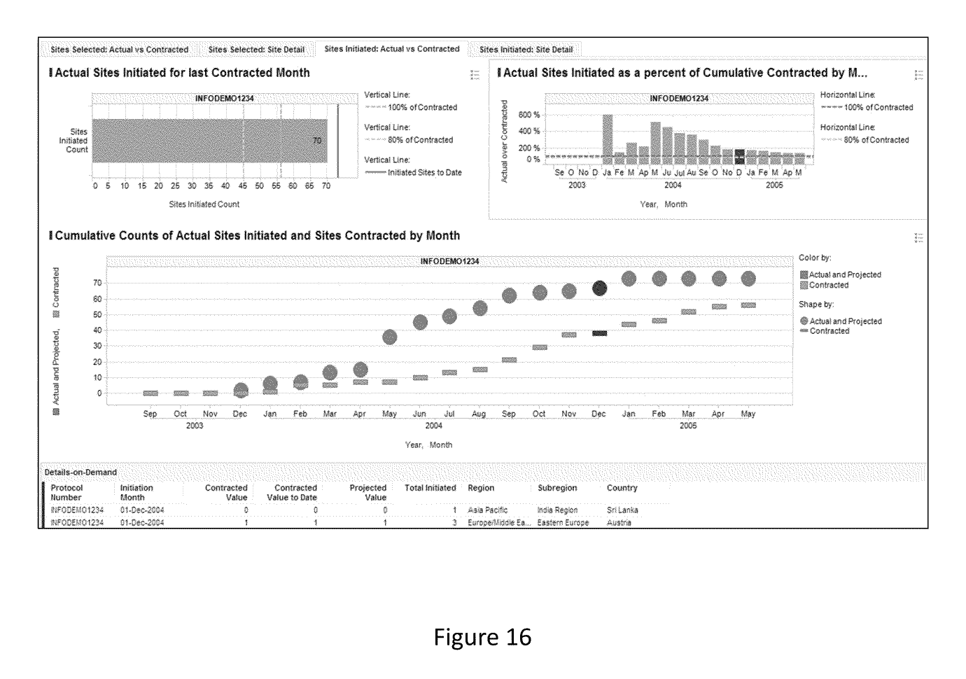

In one embodiment, a system for data visualization generates and displays a visualization of the SINIT SI. For example, FIG. 16 shows a visualization of the SINIT SI according to one embodiment. In the embodiment shown in FIG. 16, the system presents several graphical visualizations to a user. The first shows a study-level visualization of the number of sites initiated within the last month. In addition, this visualization includes graphical indicators of two thresholds, such as those described above. In this embodiment, the first threshold is set at 100% of a target value and the second threshold is set at 80% of a target value. While it may not be apparent from the single bar on the graph, the bar may be color-coded based on the respective threshold it exceeds. In the embodiment shown in FIG. 16, the bar has a green color to indicate that the number of site initiations is greater than the first threshold of 100%. If the number of site initiations was between the first and second thresholds, this embodiment would display a yellow or amber-colored bar, while if the number of site initiations was less than the second threshold, the bar would have a red color in this embodiment.

The system also provides a second graphical, study-level visualization that shows the number of sites initiated as a percent of the cumulative number contracted on a month-to-month basis. As before, this second visualization provides graphical indicators of the two thresholds. The graphical indicators can provide easy, intuitive markers to allow a user to quickly determine when data values fall outside of desired ranges.

The system provides a third, study-level visualization that shows the actual and projected number of sites initiated and the number of sites contracted on a per-month basis. As can be seen this visualization provides an intuitive display of trends for the number of sites targeted to be initiated, and the actual number initiated. Thus, a user may quickly see how site initiation has progressed and may be able to identify potential issues based on the visible trends.

In addition to providing visualizations, the system may allow a user to take corrective action based on one or more of the visualizations. For example, if the user determines that site initiation is proceeding as expected, she may drill down into the data, such as on a region-by-region basis, rather than at the study level, to ensure that each region is enjoying similar success. If a user identifies potential issues, whether at the study level, the region level, or at another level, the user may contact one or more CRAs or other personnel to determine whether targeted sites will be initiated as scheduled or whether there are particular site initiation issues to be addressed.

### SI: Screened and Randomized Trends

A Screened and Randomized Trends (SRT) SI has been developed to help track the rate at which new patients are screened and randomized in a clinical trial over time

In a clinical trial, patients are selected for participation a study, give their consent to participate, and are randomly assigned to either a treatment group or a control group. In addition, a clinical trial frequently has target levels of enrollment for periods of time as the trial proceeds. Embodiments according to the present disclosure may provide a visualization of enrollment performance as compared to a targeted enrollment over a period of time. For example, in one embodiment, a system receives enrollment target values for a clinical trial for the first 12 months of the trial. After the trial has proceeded for 6 months, a visualization may be generated based on the actual number of patients enrolled each month as compared to the target number of patients to be enrolled to show a trend of patients enrolled in the trial. Such a visualization may be further subdivided into the number of patients screened and the number of patients assigned to a treatment or control group as compared to the target number of screenings and assignments.

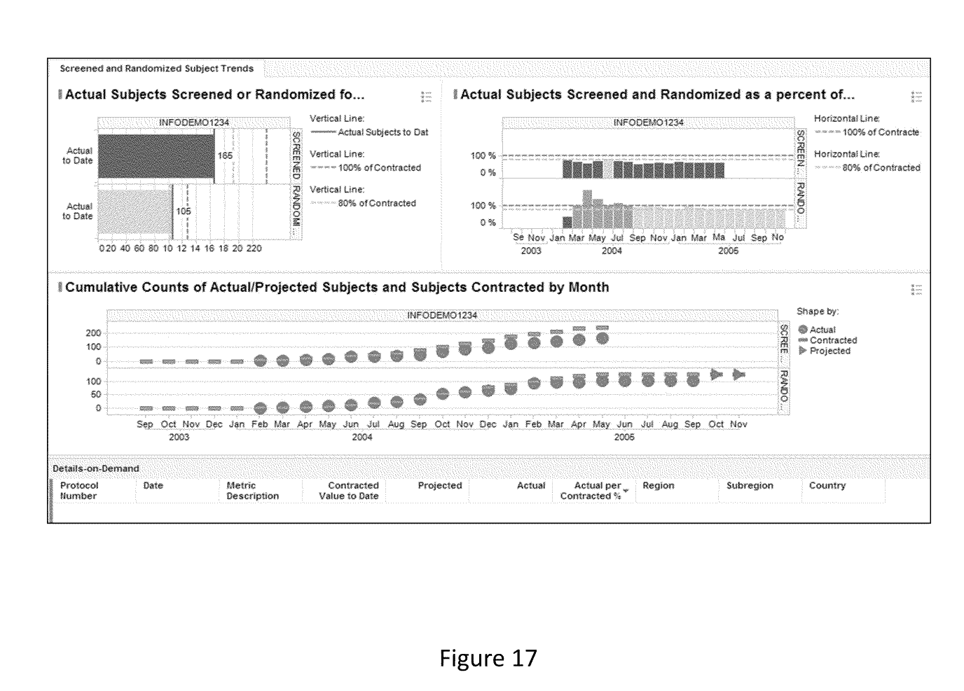

In one embodiment, a system for data visualization generates and displays a visualization of the SRT SI. For example, FIG. 17 shows a visualization of the SRT SI according to one embodiment. In this embodiment, the system provides three graphical visualizations of various SRT SI values. The first graphical visualization shows bar graphs of study-level SRT SI values for the actual number of patients screened and randomized to date. As can be seen, this visualization also provides graphical indicators for each of the defined thresholds for this SI. In this embodiment, a first threshold has been established at a value equal to 100% of the contracted number of patients, and a second threshold has been established at a value equal to 80% of the contracted number of patients. Each of the thresholds has a corresponding graphical indicator in this embodiment. Such a feature may allow a user to immediately ascertain whether a particular SI value is within an acceptable range or may indicate a potential issue. In addition, the color of each bar graph indicates the particular range the SI value falls within. As can be seen, the ‘patients screened’ bar is colored red, which indicates that the SI value falls below the second threshold, which can also be seen based on the width of the bar graph with respect to the indicator for the second threshold. The bar graph for the patients randomized is yellow or amber in this embodiment, which indicates that the SI value falls between the first and second thresholds, which may also be seen based on the width of the bar.

The system also provides a second visualization comprising additional bar graphs. In this embodiment, the additional bar graphs represent month-by-month SRT SI values for patients screened and patients randomized. As may be seen, the heights of the bars indicate the respective SI values for each and the color of each bar indicates the SI's value with respect to the established thresholds: red corresponds to a value below the second threshold, yellow or amber corresponds to a value between the first and second thresholds, and green indicates a value above the first threshold. Further, graphical indicators of each threshold are provided to allow the user to determine how close to the threshold a particular SI value falls. Such a visualization may allow a user to quickly ascertain longer-term trends in patient enrollment and identify potential issues.

The system also provides a third, study-level visualization that shows the actual and projected number of patients screened or randomized and the number of patients contracted for on a per-month basis. As can be seen this visualization provides an intuitive display of trends for the number of patients targeted to be screened and randomized, and the actual number (or projected number) that have been screened and randomized. Thus, a user may quickly see how patient screening and randomization has progressed and may be able to identify potential issues based on the visible trends.

In addition to providing visualizations, the system may allow a user to take corrective action based on one or more of the visualizations. For example, if the user determines that patient screening and randomization is proceeding as expected, she may drill down into the data, such as on a region-by-region basis, rather than at the study level, to ensure that each region is enjoying similar success. If a user identifies potential issues, whether at the study level, the region level, or at another level, the user may contact one or more CRAs or other personnel to determine whether targeted number of patients will be screened and randomized as scheduled or whether there are particular patient enrollment issues to be addressed.

### SI: Query Open to Answered Time

During the course of a clinical trial, queries may be generated at various sites for resolution and the trial may set a target time to respond to such queries (e.g. 5 days). If such delays are occasional, the impact may be minimal, but if delays occur more regularly, it may negatively affect the clinical trial. Thus, a query open to answered time (QT) SI has been developed to track delays in query responses and identify sites that regularly experience delays responses or to identify if a significant number of sites have issues with delays.

In one embodiment, a target query response time is received and compared against response times to individual queries at each of the sites within a clinical trial, though in some embodiments, only certain clinical trial sites may be evaluated. As discussed with respect to other SIs, thresholds may be set at the site level or at the trial level to generate indicators related to the QT SI. For example, in one embodiment two site-level thresholds are established. The first threshold is reached if the average QT for a site is equal to or greater than the target QT, such as 5 days. A second threshold is reached if the average QT for a site is equal to or greater than double the target QT, such as 10 days. When a site reaches the first threshold, a first indicator may be generated, and when the site reaches the second threshold, a second indicator may be generated.

In one embodiment, two trial-level thresholds may be established based on the number of sites with average QTs greater than the target. For example, the first threshold may be reached if 20% or more of the sites have average QTs greater than the target QT, and a second threshold may be reached if 40% or more of the sites have average QTs greater than the target QT. Similar to the indicators generated for the trial-level thresholds, indicators may be generated when the trial-level thresholds are reached. For example, when the trial reaches the first threshold, a first indicator may be generated, and when the trial reaches the second threshold, a second indicator may be generated.

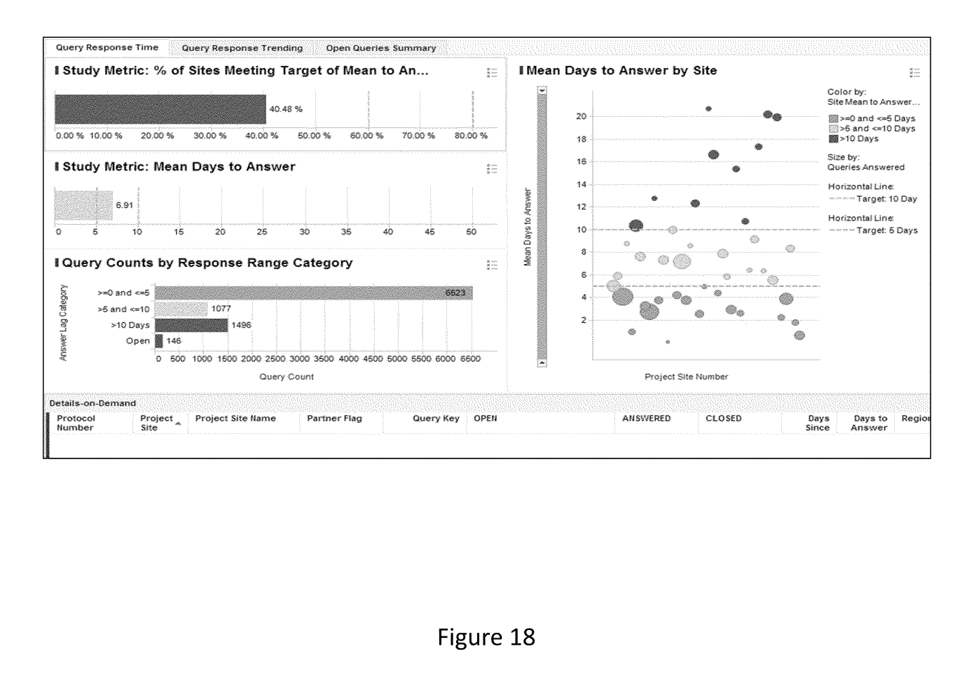

In one embodiment, a system for data visualization generates and displays a visualization of the QT SI. For example, FIG. 18 shows a visualization of the QT SI according to one embodiment. In the embodiment shown in FIG. 18, a system provides several graphical visualizations of QT SI data. The first graphical visualization provides a study-level graphical visualization showing a bar graph indicating the percentage of sites meeting the target time to answer a query. As can be seen in this embodiment, the QT SI value is 40.48%, which falls below the second threshold of 60%, and thus the bar is colored red. A yellow-colored bar would indicate that the SI value is between the first and second thresholds in this embodiment, while a green-colored bar would indicate that the SI value is greater than the first threshold. Each of the thresholds is graphically indicated in this embodiment, as can be seen in FIG. 18.

The system further provides a second study-level visualization that provides the mean days to answer a query. As may be seen this QT SI has a value of 6.91 days, which falls between the first and second thresholds of 5 and 10 days, respectively. Consequently, the bar has been colored yellow, according to this embodiment. As with the first graphical visualization in this embodiment, a red-colored bar would indicate that the SI value is below the second threshold, while a green-colored bar would indicate that the SI value is greater than the first threshold. Again, each of the thresholds is graphically indicated in this embodiment.

The system also provides a third study-level visualization in this embodiment. The third visualization provides a visualization of aggregated response times based on the time to response. The visualization shows bars corresponding to ranges of values above, below, and between the first and second thresholds, as well as for queries that have not yet been responded to. As may be seen, the width of the bars indicates the corresponding value, while the color of the bar indicates the corresponding range with respect to the two thresholds: the green bar corresponds to response times exceeding the first thresholds, the yellow bar corresponds to response times between the first and second thresholds, and the red bar corresponds to response times below the second threshold. Finally, a blue bar corresponds to the number of open queries. Such a visualization allows a user to view more detailed information regarding query response times that may not be apparent from other values. For example, the QT SI value shown in the second visualization indicates that the average response time is 6.91 days, which is between the first and second threshold, while the third visualization shows that the vast majority of response times meet or exceed the first threshold and further, that when responses are delayed, they are more likely to be substantially delayed (i.e. response times below the second threshold).

The system also provides a fourth visualization comprising a site-level visualization. As may be seen in FIG. 18, the fourth visualization provides a two-dimensional plot showing average query response times for a plurality of sites. The vertical axis of the plot indicates the average time to respond to a query while the radius of a circle indicates the number of queries answered. In addition, each of the circles is color coded to indicate where the respective site's performance falls with respect to the two thresholds. Further, the plot provides graphical indicators of the two thresholds to allow a user to quickly determine whether a site exceeds a threshold and, if so, by how large of a margin.

A user of a system according to some embodiments may take corrective action based on information provided by the visualization. For example, if the user may drill down into the study-level data, such as on a region-by-region basis, rather than at the study level, to determine if particular regions have poor performance and thus are skewing the study-level results. If a user identifies potential issues, whether at the study level, the region level, or at another level, the user may contact one or more CRAs or other personnel to determine whether one or more sites are aware of their deviation from expectations and to determine potential corrective courses of actions.

### SI: Protocol Deviations

A Protocol Deviation (PD) SI has been developed to identify sites at which protocol deviations occur at a greater rate than the study average. During the course of a clinical trial, a site may perform testing, record information, administer one or more drugs, or perform other activities according to a protocol for the clinical trial. A site that does not adhere to the protocol may generate data that is of little or no value for the trial. In one embodiment according to the present disclosure, a system for data visualization may receive data indicating protocol deviations for one or more sites within a clinical trial. The system may also calculate, or otherwise receive, an average rate of protocol deviation based on the total number of protocol deviations for the total number of patient visits (or total number of protocol deviations per total number of active patients) during a defined time period, such as during a particular month. In some embodiments, a normalized study average rate of PD is used instead of or in combination with an average rate of PD. In one embodiment, a normalized study average is based on the respective time when a study site first became active within a study. Thus, after a time period has been selected, e.g. monthly, the normalized study average is based on each site's performance during a particular month based on each sites respective start date. Thus, a site that began treating patients in month 4 of the trial will have a normalized first month at trial month 4, while a site that began treating patients in month 7 of the trial will have a normalized first month at trial month 7. Thus, relative comparisons of sites at corresponding periods of participation may be determined.

A PD SI value may be calculated for each site based on a number of protocol deviations for the site during the desired time period. In addition, one or more thresholds may be set to cause indicators to be generated if a site's PD SI value exceeds one or more of the thresholds for the desired time period. For example, in one embodiment, three thresholds are set: a first threshold set at one standard deviation from the study average, a second threshold set at 1.5 standard deviations from the study average, and a third threshold set at two standard deviations from the study average.

In some embodiments, protocol deviations may also have an associated severity, such as a non-critical PD or a critical PD. For example one or more types of PDs may be identified as critical and thus data may be tracked separately for such deviations. Such critical PDs may be compared with the total number of patient visits within a time period, e.g. a month, and subsequently compared against a threshold to identify potential issues. For example, in one embodiment, the same threshold may be used for total PDs and for critical PDs, such as a first threshold set at one standard deviation from the study average, a second threshold set at 1.5 standard deviations from the study average, and a third threshold set at two standard deviations from the study average, while in other embodiments, different thresholds may be configured.

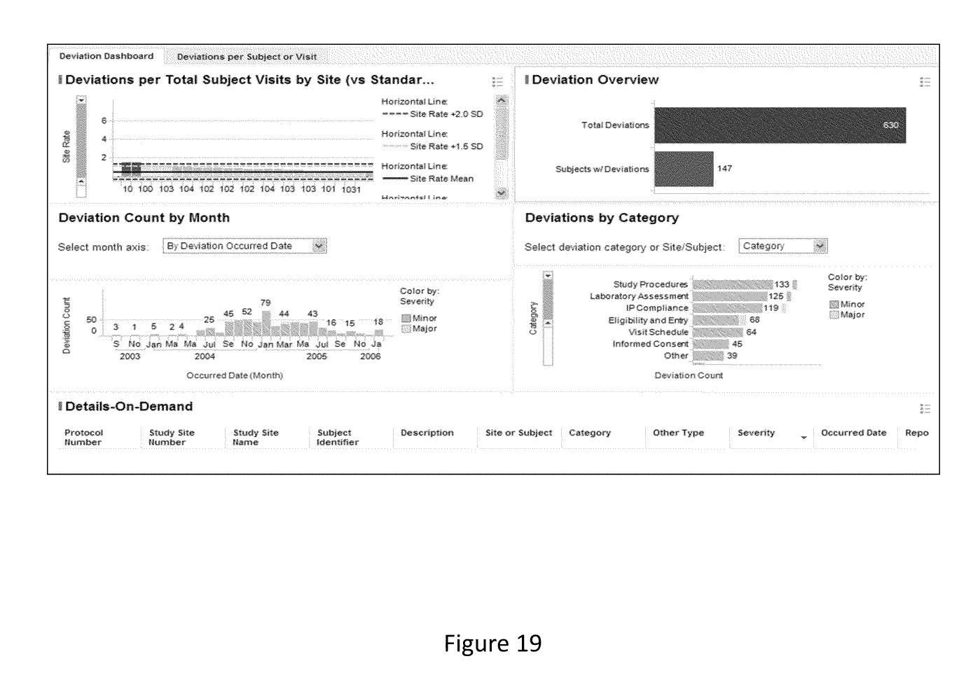

In one embodiment, a system for data visualization generates and displays a visualization of the PD SI. FIG. 19 shows a visualization according to one embodiment. In the embodiment shown in FIG. 19, a system according to this disclosure has generated four graphical visualizations for display to a user. The first visualization provides a site-level visualization comprising bar graph showing the PD SI value for each site for a given time period. In this embodiment, the bars are color-coded according to which threshold they exceed. In addition, each of the defined thresholds is shown within the visualization as a dashed line. Thus, a user is able to quickly ascertain which sites have potential issues related to protocol deviations.

The system also proves a second visualization showing the raw number of protocol deviations, both minor (or non-critical) and major (or critical). Such a visualization may allow a user to quickly identify trends related to protocol deviations over time.

The third visualization presents a bar graph showing the number of protocol deviations as well as the number of patients that have an associated protocol deviation. Such a visualization may allow a user to at least partially understand whether a common deviation is occurring with respect to most or all patients, or if a few patients are involved with a large number of protocol deviations.

The fourth visualization provides information related to the nature of the protocol deviations. For example, as may be seen, most protocol deviations relate to deviations from the study's procedures, while substantially fewer related to obtaining a patient's informed consent. In addition, the visualization provides information related to the number of critical and non-critical protocol deviation.

In some embodiments, a user may take corrective action based on information provided by one or more visualizations. For example, a user may identify one or more sites with significant protocol deviations and identify a trend associated with the site, such as an increasing number of PDs over time. The user may then contact a CRA or similar person to discuss additional corrective actions and to contact the site to schedule a visit.

### SI: Percentage of Sites Screening and Percentage of Sites Randomizing

During a clinical trial, a number of sites may participate in treating patients according to the trial's protocol. However, such sites must take in patients to do so and thus it may be important for a trial administrator to understand how many sites are actively screening and randomizing new patients. Thus, a Percentage of Sites Screening and Percentage of Sites Randomizing (PSSR) SI has been developed.

A study-level PSSR SI value may be calculated based on the total number of sites participating in the study and the number of sites that have begun screening patients, or the number of sites that have begun randomizing patients. As with other SIs, one or more thresholds may be specified. However, in some embodiments, no thresholds may be defined and instead, a trend analysis may be used to determine whether the measured percentage of sites within the study that are screening or randomizing conforms to expectations. Further, this SI may be used in conjunction with other SIs, such as the HEI SI or the SI SI, described in greater detail below.

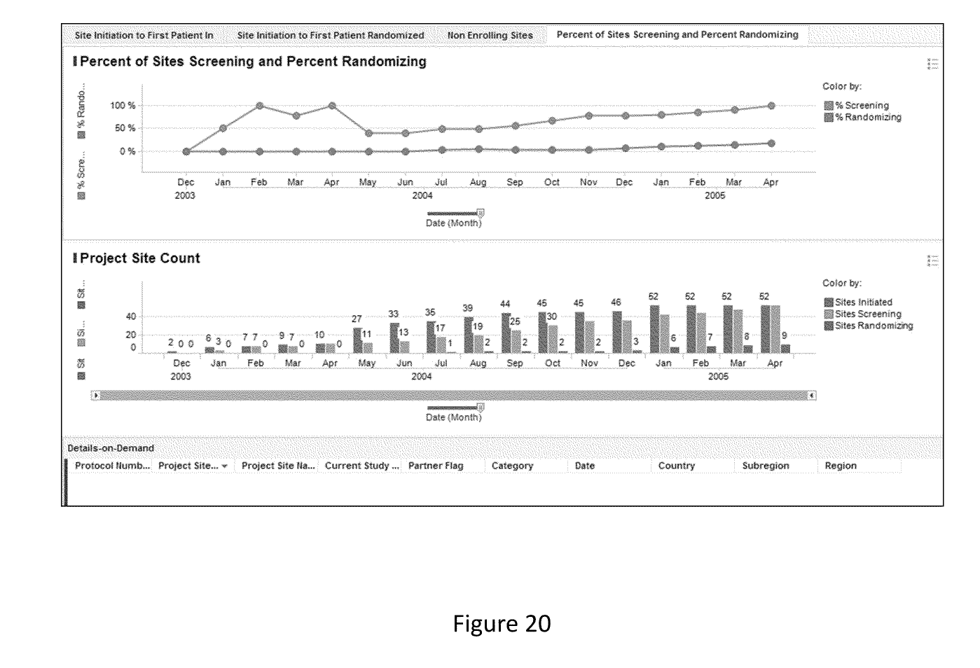

In one embodiment, a system for data visualization generates and displays a visualization of the PSSR SI. For example, FIG. 20 shows a visualization of the PSS SI according to one embodiment. In this embodiment, the visualization provides a line plot of cumulative screening and randomization rates for a study. As can be seen the visualization provides shows trends for each rate. In addition, a bar graph visualization is shown that provides indicators of the number of sites that have (a) been initiated, (b) are currently screening patients, and (c) are currently randomizing patients. Such a visualization may be used in conjunction with other SIs to provide more detailed information regarding a particular site.

### SI: Ratio of Work Complete Vs. Budget

Realization relates to the ratio between the percentage of work completed in a clinical trial against the percentage of the budget for the clinical trial that has been used. A Ratio of Work Complete vs. Budget (RL) SI has been developed to help identify when realization for a clinical study is outside of expected values. For example, in one embodiment, an amount of revenue generated to date is compared against the timesheet cost to date for sites participating in the study. In this embodiment, three thresholds have been defined: (1) 75%, (2) 85%, (3) and 120%.

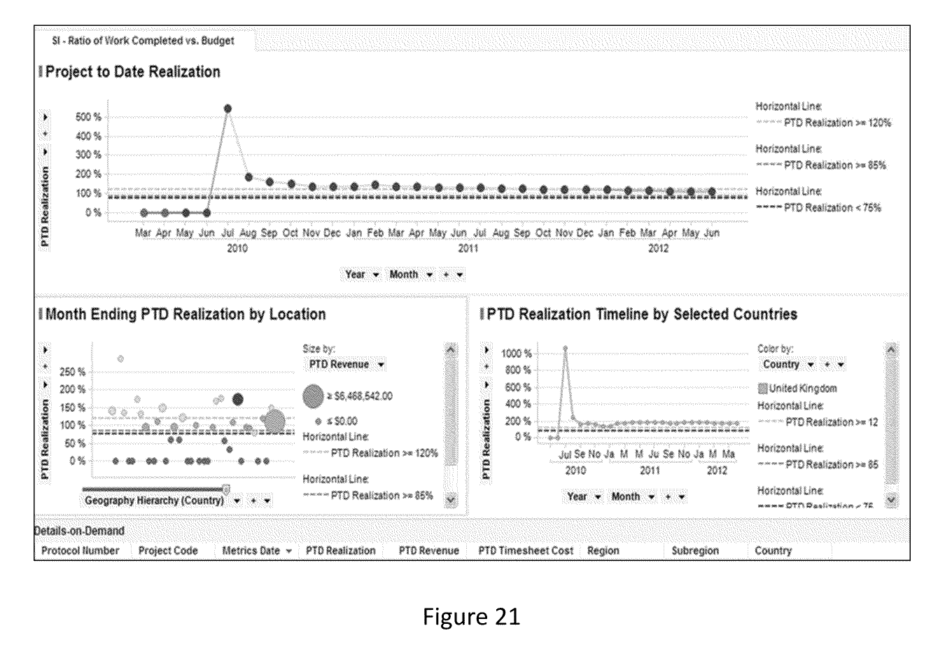

In one embodiment, a system for data visualization generates and displays a visualization of the WB SI. FIG. 21 shows a visualization according to one embodiment. In the embodiment shown, the visualization comprises a line plot showing RL SI values over a period of approximately 2 years. Each data point indicates the RL SI value for the corresponding month. In addition, the plot includes indicators for each of the threshold values: 75%, 85%, and 120%. Thus a trend line may be immediately compared against the various thresholds to identify potential problems.

In addition, the visualization provides for data indicating RL SI values computed for particular regions, such as countries. The visualization shows circles with radii corresponding to an amount of revenue generated for the respective country. Each region's (or country's) data point is displayed within a two-dimensional plot area with an axis indicating the ratio of revenues to timesheet cost. The location within the plot relative to this axis indicates the relative performance of each plotted region or country. In addition, dashed horizontal lines are provided to indicate the three defined thresholds for this embodiment.

The third plot shows a line plot for one or more selected countries or regions, similar to the line plot for the full study. Thus, a particular country's RL SI trend may be viewed and compared with the trend for the full study. Such a visualization may allow a user to quickly identify particular countries or regions having RL SI value trends that vary significantly from the trend for the study.

### SI: Monitor Productivity—SDV (Source Data Verification)

A SI for determining Monitor Productivity (MP) has been developed to determine relative performance levels of different monitors within a clinical study. As a clinical trial proceeds, source data must be verified by a monitor. The rate at which a monitor verifies pages of source data can be used to determine the monitor productivity level.

To determine a MP SI value, the number of source document verifications (SDV) completed by the monitor is compared against number of monitoring days spent at a site. The MP SI value may then be compared against the mean SDV rate for the study to help determine a monitor's productivity. In some embodiments, thresholds may be employed to identify potential issues, such as unproductive monitors or monitors whose productivity numbers are high enough that they raise questions of credibility. For example, in one embodiment, a first threshold may be set at +/−1 SD from the study mean and a second threshold may be set at +/−2 SD from the study mean. If a monitor's MP SI reaches the first threshold, a first indicator may be generated, and when the site reaches the second threshold, a second indicator may be generated. In addition, because the thresholds are both above and below the mean, separate indicators may be sent based on, for example, whether monitor's MP SI value is less than −1 SD from the mean than if the monitor's MP is greater than 1 SD from the mean.

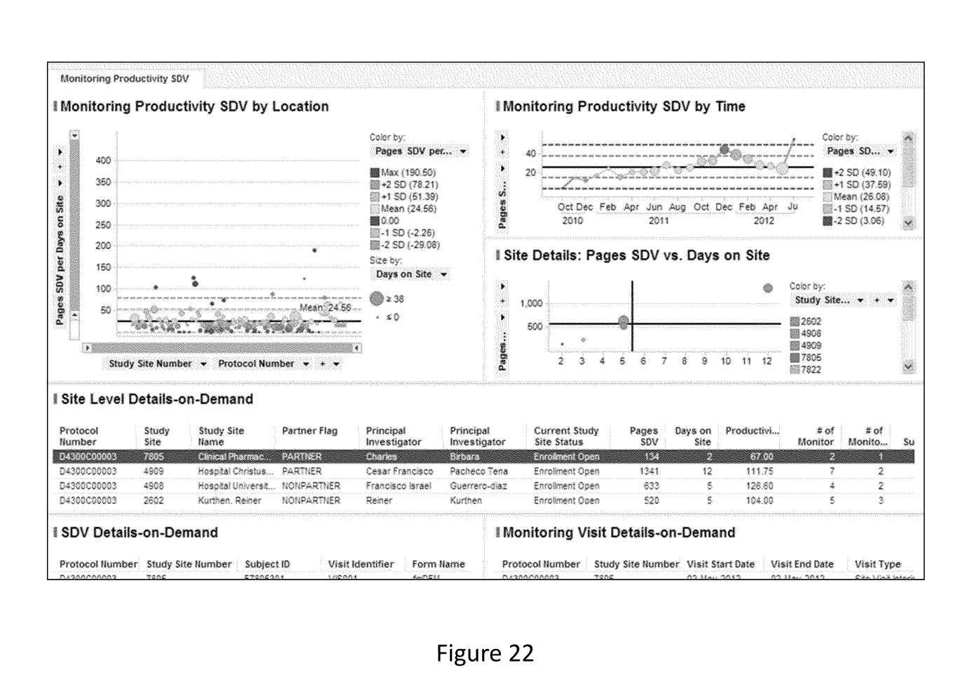

In one embodiment, a system for data visualization generates and displays a visualization of the MP SI. FIG. 22 shows a visualization according to one embodiment. In the embodiment shown, the visualization comprises three different graphical visualizations. The first visualization comprises a two-dimensional plot showing the ratio of the number of pages of source data verified documents to the number of days spent at a trial site.

The second visualization provides trending information for a particular monitor's productivity on a month to month basis. As may be seen, the monitor's MP SI score is represented by a circle, in this embodiment. The radius of the circle is based on the number of pages of SDVs performed by the monitor, while the position and color of each circle is based on the MP SI value. Further, the visualization provides graphical indicators corresponding to each of the defined thresholds. Such a visualization may allow a user to quickly identify a monitor's productivity trend or identify if a particular monitor is unproductive.

The third visualization comprises a two dimensional plot that displays circles corresponding to an actual number of pages SDV against the actual number of days on site. Thus, for example, the circle corresponding to site 2602 had approximately 500 pages SDV during 5 days of an on-site visit. Such a visualization may provide information regarding which sites have better or worse rates of pages of SDV per monitoring day on site. For example, if the rate of pages of SDV per day on site is constant, the expected result would be circles corresponding to different sites beginning in the lower left of the visualization and increasing linearly in number of pages SDV for each additional day on site. For sites that deviate from the average, their respective vertical position within the plot will deviate from such a linear increase and will be apparent to a user viewing the visualization.

In addition to the graphical visualizations, this embodiment also provides a table including detail information about different study sites, including information about the principal investigators, the number of pages SDV, and the number of days on site. Such detail information may be obtained by selecting a site in the first visualization, which may then add a corresponding circle to the third visualization and a row to the table.

In addition to providing visualizations, some embodiments provide systems that allow for corrective action based on such visualizations. For example, in one embodiment, a user may identify monitors that are either under-productive or over-productive relative to the study mean. For example, a user may identify a monitor with a MP SI value between the first and second threshold as a monitor to “watch,” while a monitor with a MP SI value above the second threshold may be identified for corrective action. After one or more monitor has been identified for corrective action, the user may contact the monitor to determine the processes used for SDV and whether the SDV forms are being completed efficiently. In some embodiments, the user may refer the CRA to a supervisor or a study administrator for corrective action, such as additional training

### SI: Cycle Time Between Patient Visit and Data Entered

During a clinical trial visit, data may be recorded by personnel at the clinical trial site and later entered into a data store. It is preferable in most cases for data to be entered relatively quickly after the visit to reduce the risk of lost data, reduce potential safety concerns, improve decision making, or for other reasons. Thus, a SI to track the cycle time between patient visit and data entered (TDE) has been developed.

In one embodiment, when data from a clinical trial site is entered for a patient visit, the date of the patient visit is compared against the date the data was entered and the delay is calculated. In this embodiment, if the delay is greater than 7 days, the data is flagged as being entered late. A study-level TDE SI percentage may be calculated based on the number of sites in the study with late data entries within a pre-determined interval. In addition, site-level TDE SI values may be calculated based on the number of late data entries within a pre-determined interval. In addition, thresholds may be defined for study-level and site-level TDE SI values.

For example, in one embodiment, study-level thresholds are established to generate a first indicator if 20% or more of sites have entered data late within the past month, and a second indicator if 30% of more of sites have entered data late within the past month. In one embodiment, site-level thresholds are established to generate a first indicator if the site has data entry times of more than 7 days, and a second indicator if the site has data entry times of more than 13 days.

A user may employ data provided by the TDE SI to identify potential corrective actions to take. For example, in one embodiment, a user may contact a low-performing site to identify existing procedures and staffing levels.

### SI: Overdue Action Items

During a clinical trial, trial sites may generate action items that require follow-up action by one or more persons at the site. If an action item, or multiple action items, remains uncompleted for too long, an indicator may be generated, or if too many sites have too many overdue action items, another indicator may be generated. Thus, an Overdue Action Item (OAI) SI has been generated to identify potential issues related to too many overdue action items within a clinical trial.

In one embodiment, a number of data points are tracked related to an OAI SI value. First, a due date is generated upon the creation of a new action item. In this embodiment, a due date is automatically generated 30 days from the creation date of the action item. An overdue ‘lag’ value is calculated based a date that is either 30 days after the action item due date or, if an intervening visit has occurred, the date of the intervening visit. When an action item is completed on time, an AI Completed value is stored for the action item. If the action item is completed late, but before the overdue ‘lag’ period expires, an AI Completed Late value is stored for the action item. Finally, if the action item is completed after the overdue ‘lag’ period expires, an AI Completed Overdue value is stored for the action item. Similarly, values corresponding to the status of an uncompleted action item are stored based on the time elapsed from the creation of the action item: an AI On-Track value is stored if the due date has not yet arrived, an AI Late value is stored if the due date has passed, but the lag period has not expired, and an AI Overdue value is stored if the lag period has expired.

The embodiment described above, a study-level OAI SI value may be calculated based on the percentage of sites having more than a threshold number of overdue action items. For example, in one embodiment, a study-level OAI SI value may be based on the percentage of sites with more than 5 overdue action items. The site-level OAI SI value may be used to generate an indicator based on one or more pre-determined threshold values. For example, in one embodiment, three thresholds may be set: normal, elevated, critical. The normal threshold corresponds to a study-level OAI SI value in which 20% or fewer of the sites have 5 or more overdue action items. The elevated threshold corresponds to a study-level OAI SI value of greater than 20% by less than 30%. Finally, the critical threshold corresponds to a study-level OAI SI value of 30% or more.

In addition, a site-level OAI SI value may be calculated based on the number of overdue action items at the site. Similar to the study-level OSI SI value, the site-level OAI SI value may be classified based on one or more thresholds. For example, in one embodiment, three thresholds may be set: normal, elevated, critical. The normal threshold corresponds to a site-level OAI SI value in which the site has 4 or fewer overdue action items. The elevated threshold corresponds to a site-level OAI SI value in which the site has 5 to 10 overdue action items. Finally, the critical threshold corresponds to a site-level OAI SI value in which the site has more than 10 overdue action items. For the study-level and site-level OAI SI values, one or more indicators may be generated based on the threshold for the respective SI value(s).

### SI: Out of Range Lab Values

An Out of Range Lab Values (ORLV) SI has been developed to identify sites at which patients' lab values exceed one or more alert value thresholds.

In one embodiment of a system for data visualization according to this disclosure, to determine an ORLV SI value, a threshold is set for a lab value. Over a set period of time, such as weekly, the number of patients with lab values exceeding the threshold is determined as a percentage of the number of patients. In this embodiment, two thresholds are used: a first threshold and a second threshold. The first threshold is set to 10% and the second threshold is set to 20%. Thus, if the ORLV SI value exceeds the first threshold, a first indicator is generated, and if the ORLV SI value exceeds the second threshold, a second indicator is generated.

In some embodiments, ORLV SI values may be calculated only for particular lab tests. For example, in one embodiment, ORLV SI values may be calculated only for liver function tests. In such an embodiment, if more than 10% of patients in the clinical trial have liver function test results exceeding a threshold, a first indicator is generated, and if more than 20% of patients in the clinical trial have liver function test results exceeding the threshold, a second indicator is generated.

### SI: SAE Reporting

As discussed previously, during a clinical trial, patients may experience serious adverse events (SAEs), potentially resulting from the drug or protocol being evaluated. Such SAEs are reported by the trial sites to the CRO or to the sponsor. However, delayed reporting of SAEs can have a negative effect on other patients and the trial itself. Thus, a SAE Reporting (SR) SI has been developed to assist in identifying when delayed SAE reporting occurs frequently.

For example, in one embodiment, SAE reporting is tracked over pre-determined intervals, such as per month. For each month, for each reported SAE, if the interval between the occurrence of a SAE and the report date for the SAE is greater than 24 hours, then the SAE report is flagged as late. As with other SIs, study-level and site-level SIs may be calculated. In addition, thresholds may be set at the study level based on the percentage of sites that reported one or more SAE late within a pre-determined interval. For site-level SR SI values, thresholds may be set based on the number of late SAE reports within the pre-determined interval. As with other SIs, one or more thresholds may be defined for each the study-level SI values and the site-level SI values.

### SI: Serious Adverse Event Trends

A Serious Adverse Event Trends (SAE) SI has been developed to track the number of SAEs during a clinical trial. In one embodiment, the SAE SI is configured to identify one or more clinical trial sites with SAE totals that are substantially above or substantially below the average incidence of SAEs in the clinical trial. For example, in one embodiment, the SAE SI value for a site is calculated based on a number of SAEs per randomized patient for the site. A study average is computed based on the number of SAEs per patient. In one embodiment, a plurality of thresholds are configured to identify potential issues, either for a particular site or if a percentage of the total sites has elevated SAE SI values. For example, a threshold may be set such that if a site's SAE SI value is more than double the study average, an indicator is generated.

In another embodiment, if the percentage of sites with SAE SI values greater than the threshold is greater than first aggregate threshold, then a first aggregate indicator is generated. For example, if the threshold is the threshold described above and the first aggregate threshold is 5% of all sites, then if 5% of all sites have SAE SI values of double or more than the study average, a first aggregate indicator is generated. In one embodiment, if the percentage of sites with SAE SI values greater than the threshold is greater than a second aggregate threshold, then a first aggregate indicator is generated. For example, if the second aggregate threshold is 10% of all sites, then if 10% of all sites have SAE SI values greater than double or more than the study average, a second aggregate indicator is generated.

### Illustrative Notifications

As discussed above with respect to various example SIs, embodiments according to this disclosure may be configured to generate one or more indicators (also referred to as notifications), such as when a SI value reaches or exceeds a threshold value. Many different types of suitable notifications are contemplated by this disclosure. For example, a notification may comprise an email that is generated and transmitted to a recipient. For example, such an email may include an identification of the SI for which the notification is being generated, a time associated with the notification, an indication of whether the notification relates to a site-level or a trial-level SI, an indication of whether one or more thresholds has been met, or an indication about a SI value or SI values. Thus, the notification may include one or more data values selected to provide information to the recipient to enable the recipient to identify any potential issues and take action.

In some embodiments, other types of notifications may be used. For example, in some embodiments that employ graphical visualizations of SI data, a SI value meeting or exceeding a threshold may have a different color, e.g. red, than other SI values that are below the threshold, e.g. green. In some embodiments, an indicator or notification may be provided by graphically displaying a threshold on a visualization and displaying a SI value outside of an area at least partially bounded by the threshold.

In some cases, more urgent notifications may be provided, such as text or SMS messages, beeper or pager messages, or popup windows on a computer screen. Such urgent notifications may be sent under specific conditions, such as if a SI value changes dramatically, if a SI value exceeds a threshold for a first time, or if a SI value that has been predefined to be of ‘high’ importance. In such cases, more rapid response may be desired and thus more immediate forms of notification may be employed in lieu or, or in concert with, other types of notifications.

### Data Visualizations

Embodiments according to this disclosure may provide one or more visualizations of clinical trial data applied to one or more SIs. For example, in one embodiment a visualization provides a graphical representation of various SI values and a graphical indication of whether each of the SI values is above one or more thresholds.

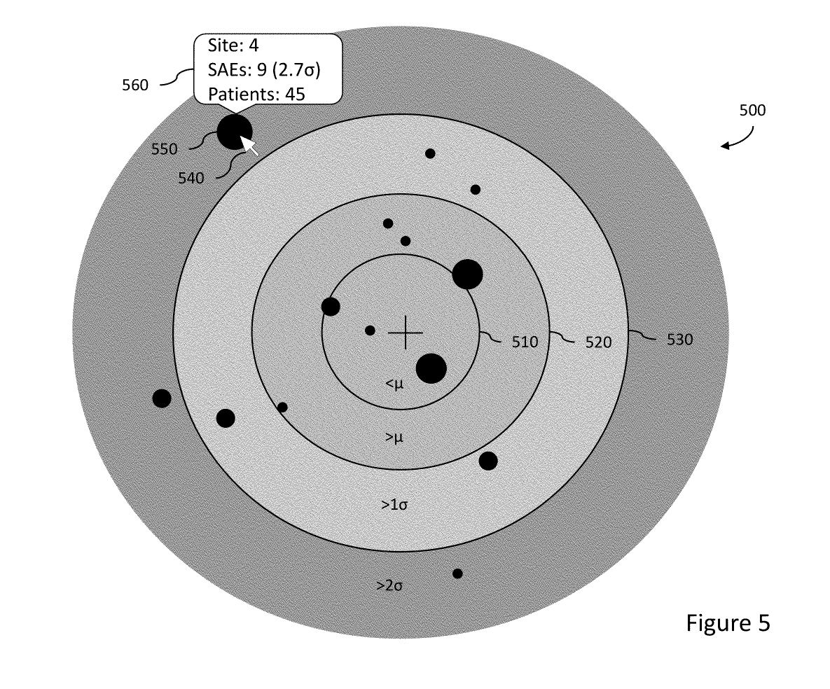

For example, a visualization 500 in one embodiment is shown in FIG. 5. The embodiment shown in FIG. 5 comprises an area bounded by several concentric circles 510-530. The innermost concentric circle 510 represents a mean value (μ) for the SI represented in the visualization 500, serious adverse events (SAE) in this embodiment. The next concentric circle 520 represents a first threshold, one standard deviation (σ) above the mean in this embodiment. The third concentric circle 530 represents a second threshold, two standard deviations above the mean in this embodiment. The various circles each represent a site participating in the trial, where the size of the circle represents the number of patients enrolled at the respective site. The distance of a circle from the center of the area represents the number of SAEs occurring at that site with respect to the mean for the trial. The axial location within a particular bounded area is selected at random in this embodiment to provide separation between various circles having similar SAE values.

Thus, a SI value exceeding the first threshold may be displayed as being located within the area between the circles 520, 530 representing first and second thresholds, while a SI value exceeding the second threshold is displayed outside of the outermost circle 530. Such a visualization may allow a user to quickly and easily identify potential issues. Further, in the embodiment shown, a user may “mouse over” a circle (representing a trial site) to obtain more detailed information about the site. In this embodiment a mouse cursor 540 has been placed on a circle 550, which causes a pop-up bubble 560 with detailed information about the site. In this embodiment, the circle 550 represents trial site number 4, which has 45 enrolled patients and has 9 reported SAEs, which is 2.7 standard deviations above the mean SAE value for the study. Thus, the circle 550 has been located beyond the circle 530 representing the second threshold. Further, in some embodiments, the concentric areas may be color-coded. For example, in the embodiment shown in FIG. 5, the areas between the center of the circular region and the first threshold is colored green, the area between the first and second thresholds is colored orange, and the area outside of the second threshold is colored red.

Still other types of visualizations are within the scope of this disclosure. For example, FIG. 1 shows two other types of visualizations according to one embodiment.

### Illustrative Method for Data Visualization

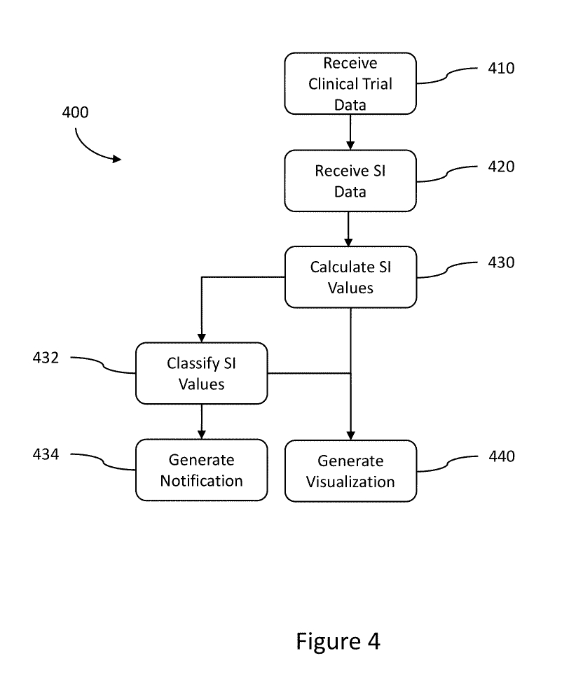

Referring now to FIG. 4, FIG. 4 shows a method 400 for data visualization in accordance with one embodiment. The method shown in FIG. 4 will be described with respect to the system shown in FIG. 3, though other suitable systems according to this disclosure may be employed as well.

The method 400 begins in block 410 where clinical trial data is received. In this embodiment, clinical trial data is received from the database 320. Clinical trial data may comprise data about a number of different aspects of the trial, including patients, visits, study sites, and the study itself. These different types of data provide rich opportunities to extract data and perform analysis to identify potential issues during the clinical trial.

Prior to receiving the clinical trial data, database requests may be generated and transmitted to the database 320 for clinical trial data relevant to one or more SIs. For example, in one embodiment that includes an AE SI, data related to adverse events may be requested from the database and subsequently received. After clinical trial data has been received, the method 400 proceeds to block 420.

At block 420, SI data is received. In one embodiment, SI data is received from the database 320. For example, SI data may comprise clinical trial data, or it may comprise data associated with a SI, such as threshold information, information regarding data relevant to the SI, sites for which to retrieve data. In some embodiments, SI data may be received via user input. For example, a user may input one or more site-level or trial-level threshold values.

After the SI data has been received, the method proceeds to block 430. At block 430, SI values are calculated. For example, in one embodiment, SI values are calculated according to a SAE SI. In one such embodiment, the received SI data comprises data about SAEs that have occurred at trial sites during a trial. According to the data, SI values, such as a mean number of SAEs occurring at any site for the trial is calculated, as well as the number of SAEs occurring at each site during the trial or during a specified time period (e.g. the past 6 months). Other SI values may be calculated as well, such as other statistical values (e.g. standard deviations, variances, median, etc.). Further, trial-level or site-level SI values may be calculated.

In addition, After block 430, in some embodiments, the method proceeds to block 432, while in some embodiments, the method proceeds to block 440.

In block 432, calculated SI values may be classified, such as according to one or more thresholds. For example, in one embodiment, SI values are compared against one or more SI thresholds. For example, after a mean SAE value is calculated, one or more SI flags may be set for each trial site based on the number of SAEs occurring at each respective trial site and whether the number of SAEs at a site meets or exceeds one or more thresholds. In this embodiment, flags are employed to indicate whether a trial site has met or exceeded each threshold. In other embodiments, other mechanisms may be used to store or indicate whether a trial site has met or exceeded a threshold. Alternatively, a comparison against one or more thresholds may be performed at a time when such information is needed. After the SI values have been classified, the method may proceed to block 434 or block 440, or both of blocks 434 and 440 may be executed.

At block 434, a notification is generated. For example, in one embodiment, a notification is generated when a SI value meets or exceeds a first threshold. For example, in the SAE embodiment described above, if a trial site records a number of SAEs meeting or exceeding a first threshold, a notification may be generated, and if the number of SAEs meets or exceeds a second threshold, a second notification may be generated. Alternatively, only one notification may be generated for the highest threshold met or exceeded. As discussed above, many different types of notifications may be generated, such as emails, visualizations or visual cues, text messages, SMS messages, MMS messages (e.g. including spoken messages), pager messages, popup messages, etc. After such notifications are generated at block 434, they are transmitted, such as by displaying the notification or transmitting the notification via a communications link to a recipient.

At block 440, a visualization is generated. For example, in one embodiment, as shown in FIG. 1, a visualization comprises a graphical display of one or more SI values associated with a clinical trial. As discussed above, the visualization employs visual indicators for SI values, including the magnitude of a particular SI value, one or more thresholds, a mean or average SI value, and other information. Still further visualizations may be generated, such as one or more of the example visualizations discussed above.

After the method has executed, it may be re-executed for one or more additional SIs, or may be performed again for the same SI. For example, it may be advantageous to periodically execute the method to track SI values over time and identify potential new issues.

### General

While the methods and systems herein are described in terms of software executing on various machines, the methods and systems may also be implemented as specifically-configured hardware, such a field-programmable gate array (FPGA) specifically to execute the various methods. For example, referring again to FIGS. 2-3, embodiments can be implemented in digital electronic circuitry, or in computer hardware, firmware, software, or in a combination of thereof. In one embodiment, a device may comprise a processor or processors. The processor comprises a computer-readable medium, such as a random access memory (RAM) coupled to the processor. The processor executes computer-executable program instructions stored in memory, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable media, that may store instructions that, when executed by the processor, can cause the processor to perform the steps described herein as carried out, or assisted, by a processor. Embodiments of computer-readable media may comprise, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the invention.

Reference herein to “one embodiment” or “an embodiment” means that a particular feature, structure, operation, or other characteristic described in connection with the embodiment may be included in at least one implementation of the invention. The invention is not restricted to the particular embodiments described as such. The appearance of the phrase “in one embodiment” or “in an embodiment” in various places in the specification does not necessarily refer to the same embodiment. Any particular feature, structure, operation, or other characteristic described in this specification in relation to “one embodiment” may be combined with other features, structures, operations, or other characteristics described in respect of any other embodiment.

Use of the conjunction “or” herein is intended to encompass both inclusive and exclusive relationships, or either inclusive or exclusive relationships as context dictates.

That which is claimed is:

1. A method, comprising:
receiving data from a clinical trial;
retrieving data relevant to a study indicator (SI) from a plurality of data entities;
calculating a plurality of SI values, each calculated SI value based on the data from one of the plurality of data entities;
generating a graphical visualization comprising:
a graphical region indicating one or more ranges of values;
a plurality of graphical indicators, each of the plurality of graphical indicators corresponding to one of the of plurality of SI values,
wherein each of the plurality of graphical indicators is positioned within the graphical region based on the respective corresponding SI value and the one or more ranges of values, and
displaying the graphical visualization.

2. The method of claim 1, further comprising:
assigning a classification to each of the plurality of SI values based at least in part on a threshold value.

3. The method of claim 2, wherein assigning the classification to each of the plurality of SI values is based at least in part on a plurality of threshold values.

4. The method of claim 3, wherein the classification comprises one of a normal priority, an abnormal priority, or a critical priority.

5. The method of claim 4, further comprising generating a notification for at least one of the SI values assigned a critical priority classification.

6. The method of claim 5, wherein generating the notification comprises transmitting the notification to at least one of a contract research organization or a clinical trial site.

7. The method of claim 1, further comprising assigning a variable visual characteristic to each the plurality of graphical indicators based on the position of the respective graphical indicator within the graphical region.

8. The method of claim 1, wherein the graphical region indicates ranges of values corresponding to a normal distribution.

9. The method of claim 1, wherein the graphical region comprises a two-dimensional plot, wherein at least one of the dimensions indicates ranges of values corresponding to a normal distribution.

10. The method of claim 1, wherein the graphical visualization further comprises:
a second graphical region indicating a second set of one or more ranges of values; and
a second plurality of graphical indicators, each of the second plurality of graphical indicators corresponding to one of the of plurality of SI values,
wherein each of the second plurality of graphical indicators are positioned within the second graphical region based on the respective corresponding SI value and the one or more ranges of values.

11. The method of claim 10, wherein displaying the graphical visualization comprises displaying the graphical region, the plurality of graphical indicators, the second graphical region, and the second plurality of graphical indicators substantially simultaneously.

12. A computer-readable medium comprising program code for causing one or more processors to execute a method, the program code comprising:
program code for receiving data from a clinical trial;
program code for retrieving data relevant to a study indicator (SI) from a plurality of data entities;
program code for calculating a plurality of SI values, each calculated SI value based on the data from one of the plurality of data entities;
program code for generating a graphical visualization comprising:
a graphical region indicating one or more ranges of values;
a plurality of graphical indicators, each of the plurality graphical indicators corresponding to one of the of plurality of SI values,
wherein the program code for generating the graphical visualization is configured to position each of the plurality of graphical indicators within the graphical region based on the respective corresponding SI value and the one or more ranges of values, and
program code for displaying the graphical visualization.

13. The computer-readable medium of claim 12, further comprising:
assigning a classification to each of the plurality of SI values based at least in part on a threshold value.

14. The computer-readable medium of claim 13, wherein the program code for assigning the classification to each of the plurality of SI values is configured to assign the classifications based at least in part on a plurality of threshold values.

15. The computer-readable medium of claim 14, wherein the classification comprises one of a normal priority, an abnormal priority, or a critical priority.

16. The computer-readable medium of claim 15, further comprising program code for generating a notification for at least one of the SI values assigned a critical priority classification.

17. The computer-readable medium of claim 16, wherein the program code for generating the notification comprises program code for transmitting the notification to at least one of a contract research organization or a clinical trial site.

18. The computer-readable medium of claim 12, further comprising program code for assigning a variable visual characteristic to each the plurality of graphical indicators based on the position of the respective graphical indicator within the graphical region.

19. The computer-readable medium of claim 12, wherein the graphical region is configured to indicate ranges of values corresponding to a normal distribution.

20. The computer-readable medium of claim 12, wherein the graphical region comprises a two-dimensional plot, wherein at least one of the dimensions indicates ranges of values corresponding to a normal distribution.

21. The computer-readable medium of claim 12, wherein the graphical visualization further comprises:
a second graphical region indicating a second set of one or more ranges of values; and
a second plurality of graphical indicators, each of the second plurality of graphical indicators corresponding to one of the of plurality of SI values,
wherein each of the second plurality of graphical indicators are positioned within the second graphical region based on the respective corresponding SI value and the one or more ranges of values.

22. The method of claim 20, wherein displaying the graphical visualization comprises displaying the graphical region, the plurality of graphical indicators, the second graphical region, and the second plurality of graphical indicators substantially simultaneously.

23. A system comprising:
a computer-readable medium; and
a processor in communication with the computer-readable medium, the processor configured to:
receive data from a clinical trial;
retrieve data relevant to a study indicator (SI) from a plurality of data entities;
calculate a plurality of SI values, each calculated SI value based on the data from one of the plurality of data entities;
generate a graphical visualization comprising:
a graphical region indicating one or more ranges of values;
a plurality of graphical indicators, each of the plurality graphical indicators corresponding to one of the of plurality of SI values,
wherein the processor is configured to position each of the plurality of graphical indicators within the graphical region based on the respective corresponding SI value and the one or more ranges of values, and
display the graphical visualization.

24. The system of claim 23, wherein the processor is further configured to assign a classification to each of the plurality of SI values based at least in part on a threshold value.

25. The system of claim 24, wherein the processor is configured to assign the classification to each of the plurality of SI values based at least in part on a plurality of threshold values.

26. The system of claim 25, wherein the classification comprises one of a normal priority, an abnormal priority, or a critical priority.

27. The system of claim 26, wherein the processor is further configured to generate a notification for at least one of the SI values assigned a critical priority classification.

28. The system of claim 27, wherein the processor is configured to generate the notification, in part, by transmitting the notification to at least one of a contract research organization or a clinical trial site.

29. The system of claim 23, wherein the processor is further configured to assign a variable visual characteristic to each the plurality of graphical indicators based on the position of the respective graphical indicator within the graphical region.

30. The system of claim 23, wherein the graphical region indicates ranges of values corresponding to a normal distribution.

31. The system of claim 23, wherein the graphical region comprises a two-dimensional plot, wherein at least one of the dimensions indicates ranges of values corresponding to a normal distribution.
